(19) United States
(12) Patent Application Publication
(10) Pub. No.: US 2025/0227591 A1
(43) Pub. Date: Jul. 10, 2025

(54) USER EQUIPMENT-CENTRIC PREDICTIVE MOBILITY

(71) Applicant: Apple Inc., Cupertino, CA (US)

(72) Inventors: Alperen Gundogan, Munich (DE); Ahmed Mohamed Ibrahim Hassan, Munich (DE); Christian Hofmann, Munich (DE); Dimitrios Alanis, Munich (DE); Milan Zivkovic, Munich (DE); Nikolai Bijovski Ribakov, Munich (DE); Panagiotis Botsinis, Munich (DE); Said Medjkouh, San Diego, CA (US); Sameh M. Eldessoki, Munich (DE); Seyedamirhossein Hosseini, Jersey City, NJ (US); Tarik Tabet, San Jose, CA (US)

(73) Assignee: Apple Inc., Cupertino, CA (US)

(21) Appl. No.: 18/969,090

(22) Filed: Dec. 4, 2024

Related U.S. Application Data
(60) Provisional application No. 63/618,236, filed on Jan. 5, 2024.

(51) Int. Cl. H04W 36/30; H04W 36/00; H04W 36/32

(52) U.S. Cl. CPC H04W 36/30; H04W 36/008357; H04W 36/32

(57) ABSTRACT

The present application relates to devices and components including apparatus, systems, and methods to provide and/or implement user equipment-centric predictive mobility with subnetwork support in wireless communication systems.

### CROSS-REFERENCE TO RELATED APPLICATIONS

This application claims priority to U.S. Provisional Patent Application No. 63/618,236, entitled “User Equipment-centric Predictive Mobility,” filed on Jan. 5, 2024, the disclosure of which is incorporated by reference herein in its entirety for all purposes.

### TECHNICAL FIELD

The present application relates to the field of wireless technologies and, in particular, to user device-centric predictive mobility for a handover procedure.

### BACKGROUND

Third Generation Partnership Project (3GPP) networks allow a user equipment (UE) to establish connections with cells hosted by base stations of the networks. As the UE is physically moved within the networks, a quality of service provided by a serving cell to which the UE is connected may be reduced as the UE approaches an edge of the serving cell. The UE and the networks can perform a handover procedure to transfer the connection of the UE from the serving cell to a target cell as the quality of service provided by the serving cell becomes reduced.

### BRIEF DESCRIPTION OF THE DRAWINGS

FIG. 1 illustrates a first portion of an example signaling chart for conditional handover (CHO) in accordance with some embodiments.

FIG. 2 illustrates a second portion of the example signaling chart of FIG. 1 for CHO in accordance with some embodiments.

FIG. 3 illustrates an example subnetwork and network coordination arrangement in accordance with some embodiments.

FIG. 4 illustrates an example network cell arrangement in accordance with some embodiments.

FIG. 5 illustrates an example network arrangement in accordance with some embodiments.

FIG. 6 illustrates a first portion of an example signaling chart for a master node (MN)-centric approach in accordance with some embodiments.

FIG. 7 illustrates a second portion of the example signaling chart of FIG. 6 in accordance with some embodiments.

FIG. 8 illustrates a third portion of the example signaling chart of FIG. 6 in accordance with some embodiments.

FIG. 9 illustrates a first portion of a flowchart of an example procedure for a decision mechanism at a user equipment (UE) in accordance with some embodiments.

FIG. 10 illustrates a second portion of the flowchart of FIG. 9 in accordance with some embodiments.

FIG. 11 illustrates a signaling chart for example data collection and exchange in accordance with some embodiments.

FIG. 12 illustrates an example QoEDevice information element (IE) in accordance with some embodiments.

FIG. 13 illustrates an example QoESubnetAggregated IE and an example QoESubnet IE in accordance with some embodiments.

FIG. 14 illustrates a first portion of an example signaling chart for an MN-centric approach in accordance with some embodiments.

FIG. 15 illustrates a second portion of the example signaling chart of FIG. 14 in accordance with some embodiments.

FIG. 16 illustrates an example signaling chart of an example handover (HO) setup and procedure in accordance with some embodiments.

FIG. 17 illustrates an example of an IE sent by the UE during request via physical uplink shared channel (PUSCH) in accordance with some embodiments.

FIG. 18 illustrates an example IE in accordance with some embodiments.

FIG. 19 illustrates an example network arrangement in accordance with some embodiments.

FIG. 20 illustrates an example signaling chart for direct UE-to-UE communication in accordance with some embodiments.

FIG. 21 illustrates an example procedure for determining a target cell for an HO operation in accordance with some embodiments.

FIG. 22 illustrates an example procedure for indicating service information for a mobility decision in accordance with some embodiments.

FIG. 23 illustrates an example procedure for determining a target cell for an HO operation in accordance with some embodiments.

FIG. 24 illustrates an example UE in accordance with some embodiments.

FIG. 25 illustrates an example next generation NodeB (gNB) in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrase “A or B” means (A), (B), or (A and B); and the phrase “based on A” means “based at least in part on A,” for example, it could be “based solely on A” or it could be “based in part on A.”

The following is a glossary of terms that may be used in this disclosure.

The term “circuitry” as used herein refers to, is part of, or includes hardware components such as an electronic circuit, a logic circuit, a processor (shared, dedicated, or group) or memory (shared, dedicated, or group), an application specific integrated circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, or transferring digital data. The term “processor circuitry” may refer an application processor, baseband processor, a central processing unit (CPU), a graphics processing unit, a single-core processor, a dual-core processor, a triple-core processor, a quad-core processor, or any other device capable of executing or otherwise operating computer-executable instructions, such as program code, software modules, or functional processes.

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “computer system” as used herein refers to any type interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component within a computing environment, or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, or the like. A “hardware resource” may refer to compute, storage, or network resources provided by physical hardware element(s). A “virtualized resource” may refer to compute, storage, or network resources provided by virtualization infrastructure to an application, device, system, etc. The term “network resource” or “communication resource” may refer to resources that are accessible by computer devices/systems via a communications network. The term “system resources” may refer to any kind of shared entities to provide services, and may include computing or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link” as used herein refers to a connection between two devices for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The term “connected” may mean that two or more elements, at a common communication protocol layer, have an established signaling relationship with one another over a communication channel, link, interface, or reference point.

The term “network element” as used herein refers to physical or virtualized equipment or infrastructure used to provide wired or wireless communication network services. The term “network element” may be considered synonymous to or referred to as a networked computer, networking hardware, network equipment, network node, virtualized network function, or the like.

The term “information element” refers to a structural element containing one or more fields. The term “field” refers to individual contents of an information element, or a data element that contains content. An information element may include one or more additional information elements.

The term “based at least in part on” as used herein may indicate that an item is based solely on another item and/or an item is based on another item and one or more additional items. For example, item 1 being determined based at least in part on item 2 may indicate that item 1 is determined based solely on item 2 and/or is determined based on item 2 and one or more other items in embodiments.

Third Generation Partnership Project (3GPP) networks may consist of multiple base stations hosting multiple cells to provide service for user equipments (UEs). Each of the UEs may establish connections with a cell in an area in which the UE is located to utilize services of the networks. The UE can determine which cell to connect with based on a quality of service (QOS) provided by the cell, a strength of signal from the cell, a signal interference to noise ratio (SINR) of the cell, and/or other measurements indicating the ability of the cell to adequately provide service to the UE.

As a UE is physically moved throughout the networks, the service quality provided by a serving cell to which the UE is connected may be reduced and service qualities that can be provided by other cells to the UE may exceed the service quality provided by the serving cell. Handover (HO) operations have been defined for allowing a UE to transition its connection to a cell that can provide better service quality than a serving cell. In legacy approaches, a target cell to which the connection of the UE is to be transitioned is based on service quality measurements (including QoS measurements, signal strength measurements, and/or SINR measurements) performed by the UE. However, the ability to provide adequate service to a UE may be affected by additional factors, such as an amount of traffic being handled by a cell.

Approaches described herein provide for service information to be shared among UEs within different cells. The service information may be used for determining a target cell to which a connection for UE is to be transitioned during a HO operation. Using the service information from other UEs in other cells for determining a target cell for a UE can increase the likelihood that the target cell can provide adequate service for the UE. This can also reduce the likelihood that the UE will have to perform multiple consecutive HO operations to connect to a cell that provides adequate service, which the multiple consecutive HO operations can result in reduced service quality for the UE.

Approaches described herein may utilize user-centric predictive mobility with subnetwork support. For example, subnetworks may be established within a network as described further throughout this disclosure. A UE within a subnetwork may be selected as a managing UE (M-UE), and can communicate with other UEs within the subnetwork and/or other M-UEs in other subnetworks. The M-UE may obtain service information from UEs within the network and share the service information with UEs within the network to provide for user-centric predictive mobility with subnetwork support.

### Conditional Handover

Baseline handover (BHO) was introduced in the first release of fifth generation (5G) and allows the network to control handover decisions based on the measurement results of the UE. Performance depends on the timing of the measurement report transmission and/or HO command reception.

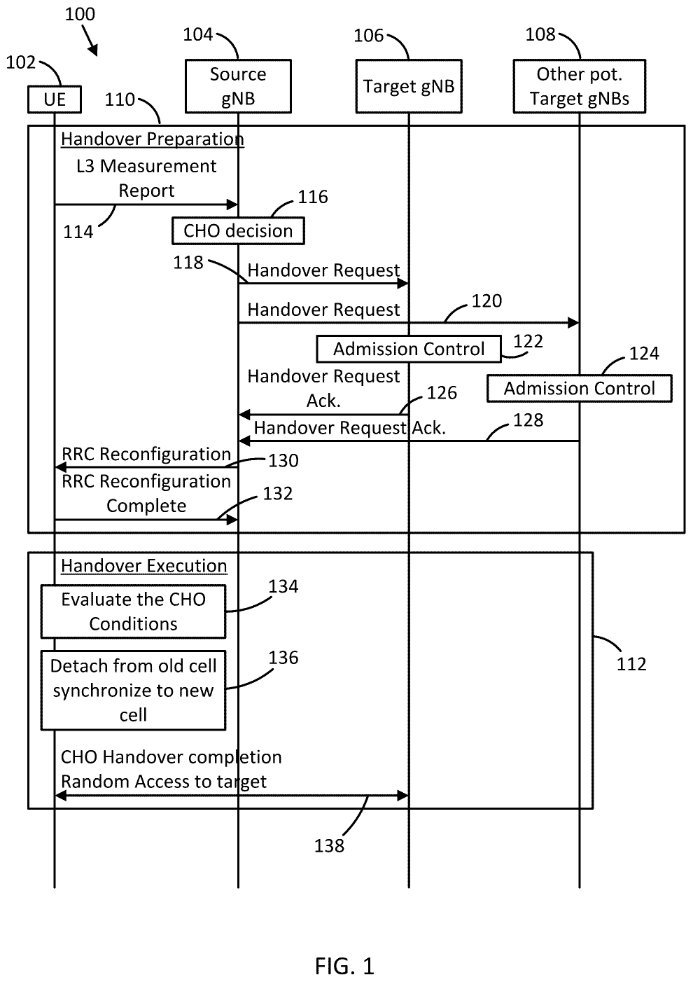

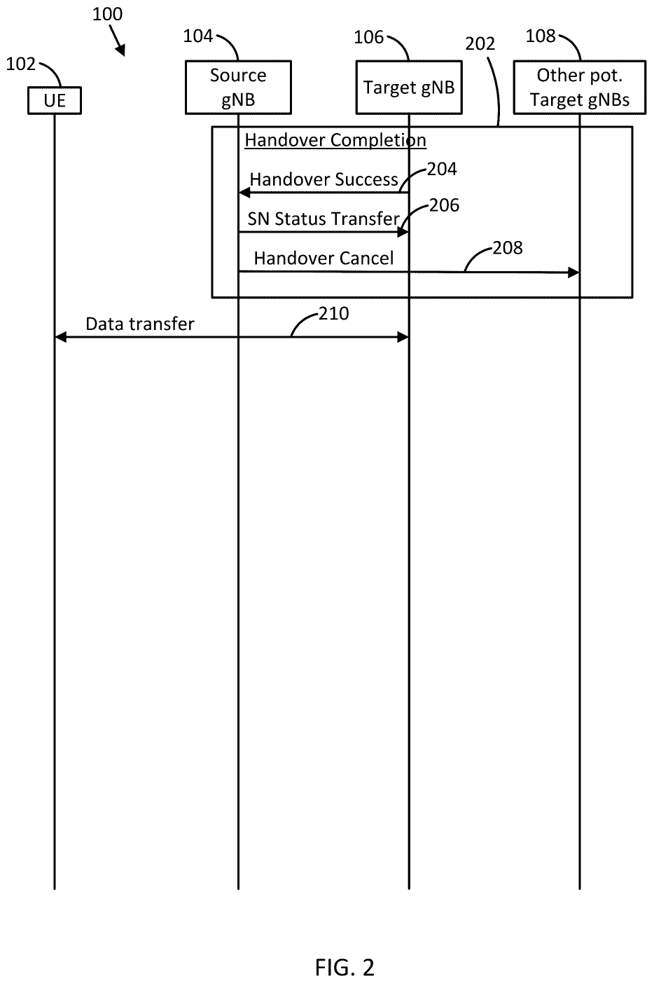

FIG. 1 illustrates a first portion of an example signaling chart 100 for conditional handover (CHO) in accordance with some embodiments. FIG. 2 illustrates a second portion of the example signaling chart 200 for CHO in accordance with some embodiments. CHO was proposed in order to reduce the service interruption time. It increases the robustness of BHO by configuring UEs with a condition to autonomously execute the handover.

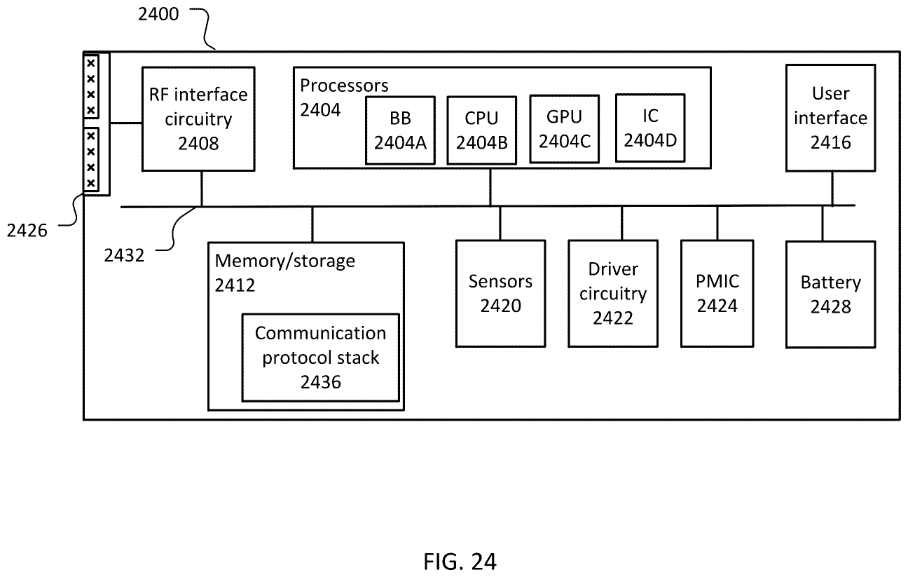

The signaling chart 100 includes a UE 102. The UE 102 may include one or more of the features of the UE 2400 (FIG. 24).

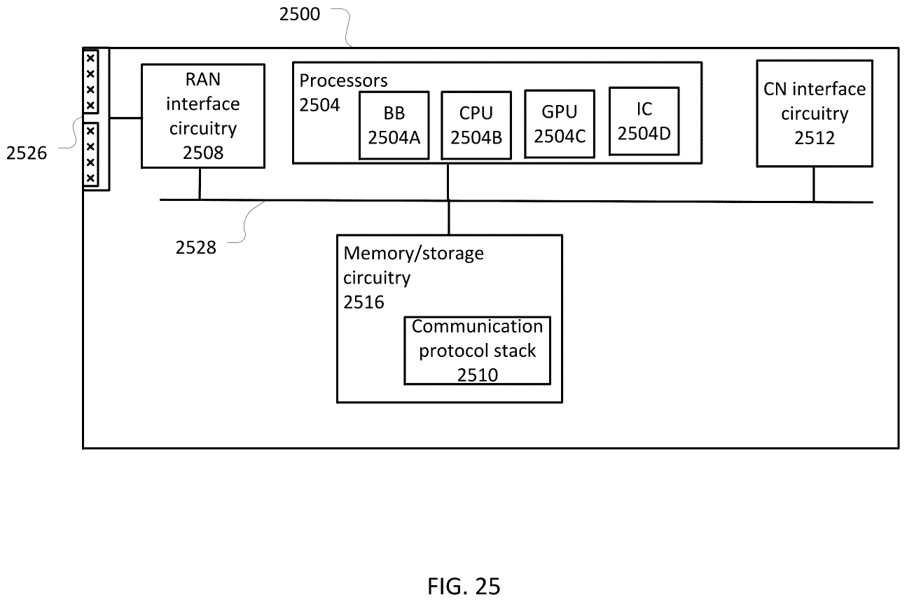

The signaling chart 100 includes a source base station 104 and a target base station 106. The signaling chart 100 further includes other potential target base stations 108, although it should be understood that the other potential target base stations 108 may be omitted in other instances. Each of the source base station 104, the target base station 106, and the other potential target base stations 108 may include one or more of the features of the gNB 2500 (FIG. 25). Further, each of the source base station 104, the target base station 106, and the other potential target base stations 108 may host one or more cells.

The UE 102 has a connection established with the source base station 104 at an initiation of the signaling chart 100. The signaling chart 100 illustrates example HO preparation and HO execution of the UE 102 in accordance with some embodiments. For example, the example signaling chart 100 shows an HO preparation procedure 110, an HO execution procedure 112, and an HO completion procedure 202 in the illustrated embodiment.

The network provides the configurations of the potential target cells to the UE prior to the execution of CHO, based on the received measurement report. For example, the UE 102 may transmit a measurement report 114 to the source base station 104. The measurement report 114 is configured to be triggered before the UE 102 is close to the cell edge.

The source base station 104 may receive the measurement report 114 from the UE 102. The source base station 104 may process the measurement report 114 and may make a CHO decision 116 of which one or more base stations are to be configured as target base stations for the UE 102 for CHO operations. In the illustrated embodiment, the source base station 104 may determine that the target base station 106 and the other potential target base stations 108 are to be configured as target base stations for CHO operations.

The source base station 104 may perform operations for preparing the determined target base stations for CHO operations of the UE 102. For example, the source base station 104 transmits an HO request 118 to the target base station 106 and one or more HO requests 120 to the other potential target base stations 108 for the UE 102 in the illustrated embodiment. The target base station 106 may perform an admission control procedure 122 and the other potential target base stations 108 may perform one or more admission control procedures 124 to verify that the UE 102 is allowed to establish connections with the target base station 106 and/or the other potential target base stations 108 in response to receiving the HO request 118 and/or the one or more HO requests 120. The target base station 106 may respond to the source base station 104 with an HO request acknowledgement 126 and/or the other potential target base stations 108 may response to the source base station 104 with one or more HO request acknowledgements 128 to indicate that the UE 102 is allowed to connect to the target base station 106 and/or the other potential target base stations 108.

The source base station 104 may transmit a radio resource control (RRC) reconfiguration message 130 to the UE 102. The RRC reconfiguration message 130 may configure the UE 102 for CHO to the target base station 106 and/or to the other potential target base stations 108. The UE 102 may respond with an RRC reconfiguration complete message 132 indicating that the UE 102 has been reconfigured for CHO to the target base station 106 and/or the other potential target base stations 108.

Upon configuration, the UE 102 evaluates the CHO conditions set by the network based on the signal measurements, e.g., A3 event. For example, the UE 102 may evaluate the CHO conditions in 134 to determine whether the CHO conditions configured by the RRC reconfiguration message 130 for CHO have been met. If a condition is satisfied, the UE initiates random access to the target gNB. For example, the UE 102 may detach from an old cell and synchronize to a new cell in 136. The UE 102 may perform a random access procedure 134 to the target base station 106.

If random access is successful, the target gNB informs the source gNB of handover success. For example, if the random access procedure 134 is successful between the UE 102 and the target base station 106, the target base station 106 may transmit an HO success message 204 to the source base station 104 to indicate that the UE 102 has successfully completed HO to the target base station 106.

The source gNB then sends the data status to the target gNB. For example, the source base station 104 may transmit a sequence number (SN) status transfer message 206 to the target base station 106 that indicates data status for the UE 102. Further, the source base station 104 may transmit one or more HO cancel messages 208 to the other potential target base stations 108 to indicate that the CHO of the UE 102 to the other potential target base station 108 has been canceled. The UE 102 and the target base station 106 may proceed to exchange one or more data transfers 210 after completion of the HO.

### Subnetworks Coordination

Subnetworks may be established for various purposes, including augmented reality (AR)/virtual reality (VR)/holography for colocated users, in-factory/in-vehicle/in-body for interconnection of sensors/components, distributed computed to offload NW functionalities, and/or coverage extension. Distributing the network (NW) functionalities across the more capable nodes requires a coordination mechanism both within the subnetwork(s) and with the overlay third generation partnership project (3GPP) NW.

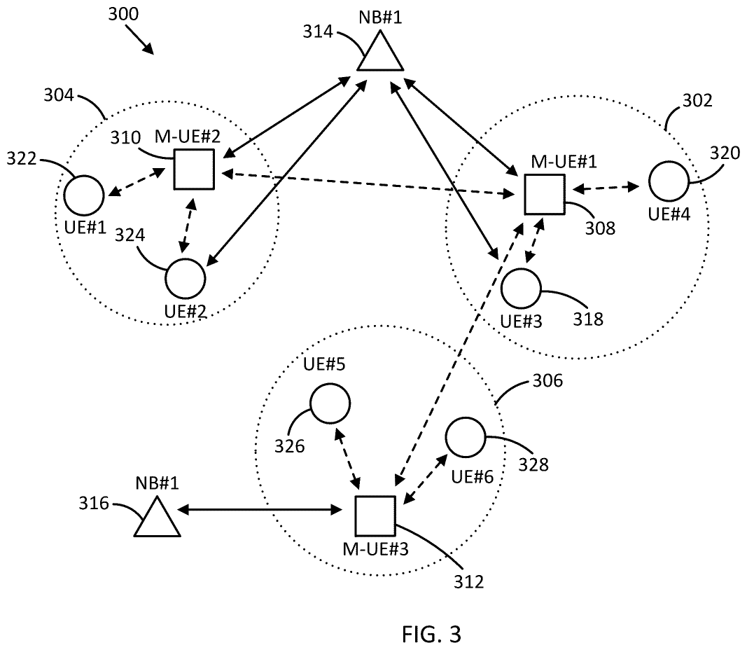

FIG. 3 illustrates an example subnetwork and network coordination arrangement 300 in accordance with some embodiments. For example, the arrangement 300 illustrates arrangements of subnetworks within a network in accordance with some embodiments.

A network may define one or more subnetworks within the network. For example, the arrangement 300 includes a first subnetwork 302, a second subnetwork 304, and a third subnetwork 306. Each of the subnetworks may be defined to include a certain area.

Each subnetwork may have a managing UE (M-UE). For example, the first subnetwork 302 may have a first M-UE 308, the second subnetwork 304 may have a second M-UE 310, and the third subnetwork 306 may have a third M-UE 312. Each of the M-UEs may include one or more of the features of the UE 2400 (FIG. 24). The M-UE may be selected based on capabilities of the M-UEs. Each of the M-UEs may be highly capable modified UEs.

Each of the M-UEs may communicate with a corresponding base station of the network. For example, the first M-UE 308 may communicate with a first base station 314, the second M-UE 310 may communicate with the first base station 314, and the third M-UE 312 may communicate with a second base station 316. Each of the base stations may include one or more of the features of the gNB 2500 (FIG. 25). In some embodiments, the M-UEs may communicate with the base stations via base station-UE links, as illustrated by the solid line arrows in the illustrated embodiment.

Further, each of the M-UEs may communicate with one or more other the other M-UEs. For example, the first M-UE 308 may communicate with the second M-UE 310 and the third M-UE 312 in the illustrated embodiment. The M-UEs may communicate with other M-UEs via M-UE-UE local links in some embodiments, as illustrated by the dashed line arrows in the illustrated embodiment.

Each of the M-UEs may be able to communicate with one or more other UEs within the corresponding subnetwork. For example, the first M-UE 308 may communicate with a third UE 318 and a fourth UE 320 within the first subnetwork 302, the second M-UE 310 may communicate with a first UE 322 and a second UE 324 within the second subnetwork 304, and the third M-UE 312 may communicate with a fifth UE 326 and a sixth UE 328 within the third subnetwork 306 in the illustrated embodiment. Each of the UEs may include one or more of the features of the UE 2400 (FIG. 24). The M-UEs may communicate with the UEs via M-UE-UE local links in some embodiments, as illustrated by the dashed line arrows in the illustrated embodiment.

One or more of the UEs may also be connected directly to the base stations. For example, the second UE 324 and the third UE 318 may have direct connections with the first base station 314 in the illustrated embodiment. The UEs may communicate with the base stations via base station-UE links in some embodiments, as illustrated by the solid line arrows in the illustrated embodiment.

### Issue Definition

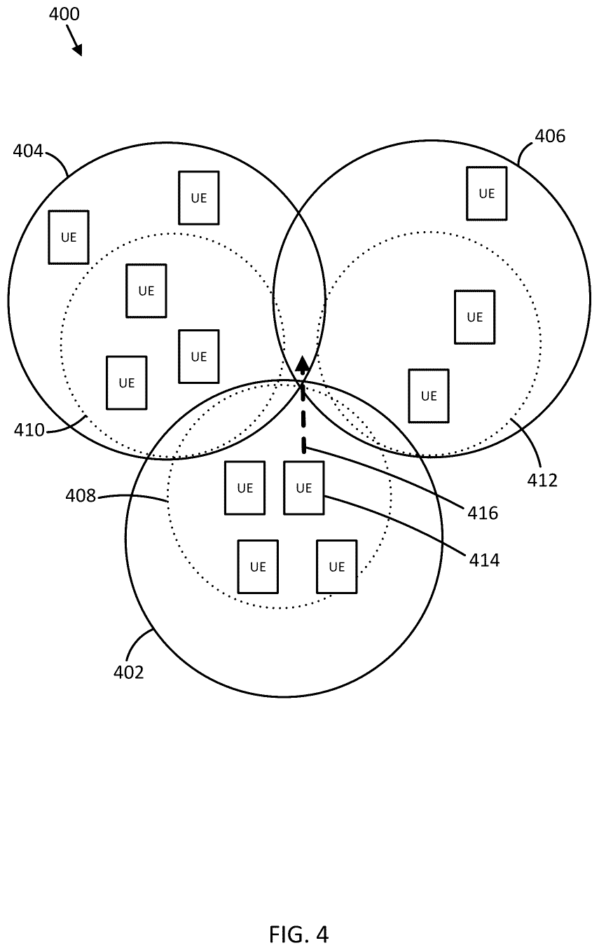

FIG. 4 illustrates an example network cell arrangement 400 in accordance with some embodiments. The arrangement 400 illustrates a movement of a UE between cells of a network. Further, the arrangement 400 illustrates subnetworks that can be defined within the network. The arrangement 400 can present the issues described below in this issue definition section.

The arrangement 400 may include one or more cells. In the illustrated embodiment, the arrangement 400 includes a first cell 402, a second cell 404, and a third cell 406, as illustrated by the solid line spheres in the illustrated embodiment. Each of the cells may be hosted by a same base station, different base stations, or some combination thereof. Each of the base stations may include one or more of the features of the gNB 2500 (FIG. 25). As seen in the illustrated arrangement 400, the cells may overlap with one or more other cells.

The arrangement 400 may include one or more subnetworks. In the illustrated embodiment, the arrangement 400 includes a first subnetwork 408, a second subnetwork 410, and a third subnetwork 412, as illustrated by the dotted line spheres in the illustrated embodiment. The subnetworks may be located within cells and can include a portion of the area of the cells. For example, the first subnetwork 408 is located within the first cell 402 in the illustrated embodiment and includes portions of the first cell 402, the second cell 404, and the third cell 406. The second subnetwork 410 is located within the second cell 404 in the illustrated embodiment and includes portions of the first cell 402, the second cell 404, and the third cell 406. The third subnetwork 412 is located within the third cell 406 in the illustrated embodiment and includes portions of the first cell 402, the second cell 404, and the third cell 406.

The arrangement 400 may include one or more UEs. As an example, the arrangement 400 includes a first UE 414. Each of the UEs may include one or more of the features of the UE 2400 (FIG. 24). Each of the UEs may be included in one or more of the cells and/or one or more of the subnetworks. For example, the first UE 414 is located within the first cell 402 and the first subnetwork 408 in the illustrated embodiment.

The UEs may be mobile and may move into different cells and/or subnetworks. For example, the first UE 414 may be moving as indicated by the arrow 416 in the illustrated embodiment. As the first UE 414 moves into different cells, a HO operation (such as a CHO) may be performed to connect the first UE 414 to different cells to maintain service. As indicated by the arrow 416, the first UE 414 may be moving into an area included within the second cell 404 and the third cell 406 in the illustrated embodiment. The first UE 414 moving into the area can present a challenge of determining which of the second cell 404 and the third cell 406 the first UE 414 should be handed over to as the first UE 414 moves into the area. Accordingly, it can be a challenge to determine which cell to select for the HO if both the second cell 404 and the third cell 406 are good.

In legacy CHO, the UE is configured with RRC reconfiguration of the potential target cells earlier, i.e., before the UE approaches the cell edge. The handover execution decision relies on the signal measurements based on pre-configured events, e.g., A3 (i.e., if target cell is stronger than the serving cell). However, even if the target signal power is good, it does not guarantee that the QoS requirements of the UE will be satisfied if the load of the target cell is high.

An assumption is that if the target QoS requirements turn out not to be satisfied in the target cell, the UE can again trigger handover to another cell. An issue with this assumption is that each handover causes service interruption time. Optimally, the UE should handover with the first try to a cell that satisfies its QoS requirements for long time.

Another assumption is that during cell preparation, the NW may consider the cell load (i.e., NW may even consider beam load, if UE includes layer 3 (L3)-Beam measurements as a part of measurement report) and may prepare the cells accordingly. An issue with this assumption is that at the time of CHO execution, the load of the target cell is unknown to the UE and it may vary depending on UE mobility, traffic patterns inside the cell, and/or CHO preparation and execution threshold.

R2-1909862 (R2-1909862, “Consecutive Conditiona [sic] Handover,” Agenda Item 11.9.3.2, 3GPP TSG-RAN WG2 Meeting #107, Prague, Czech Republic, 26th-30th August 2019) proposed a “consecutive CHO” mechanism to allow the UE to keep the prepared cells configuration even after CHO execution. RP-213565 (RP-213565, “Further NR Mobility Enhancements,” 3GPP TSG RAN Meeting #94e, Electronic Meeting, Dec. 6-17, 2021) objectives include keeping conditional primary serving cell (PSCell) change/activation (conditional PSCell change (CPC)/conditional PSCell activation (CPA)) after handover to allow subsequent cell group change without reconfiguration of CPC/CPA. An issue with these approaches is that this means that the time difference between the CHO preparation and the handover execution can be much larger, which can increase the likelihood of load change at the prepared cells.

An assumption is that UE may request load information of the target cell before CHO execution. An issue with this assumption is that this approach conflicts with the CHO logic. As the UE is approaching the cell edge, the signal quality of the serving cell degrades. As a consequence, the UE request and the serving cell response may fail to be received (i.e., considering that serving cell requires time to get load information of the target cell).

Another assumption is that after CHO configuration, the UE keeps sending periodically measurement report to the serving cell and the serving cell can request load information of the prepared cells. If needed, the serving cell can send another RRC reconfiguration to the UE. An issue with this assumption is that increased signaling between UE and NW, signaling between NW and NW signaling, and increased power consumption can occur. In addition, request and response may fail to be received right before CHO execution.

In addition, random access (RA) to the target cell might fail if the target cell is congested/highly loaded as Msg1 might fail due to collision. The UEs inside the cell can trigger RA due to beam failure recovery (BFR), RRC-reestablishment, transition from RRC_inactive to RRC connected, etc. Further, RA to the target cell might fail if the target cell is congested/highly loaded as the gNB might not be able to allocate msg2 resources within RA response time.

Mobility based on just signal measurement can degrade the QoS, as the UE is agnostic of the traffic load on the target cell, and increase the UE interruption time due to handover failure, since the UE would need to perform RRC reestablishment, which can cause up to a couple of hundred millisecond (ms) service interruption time.

### Brief Description of an Approach (Master Node (MN)-Centric)

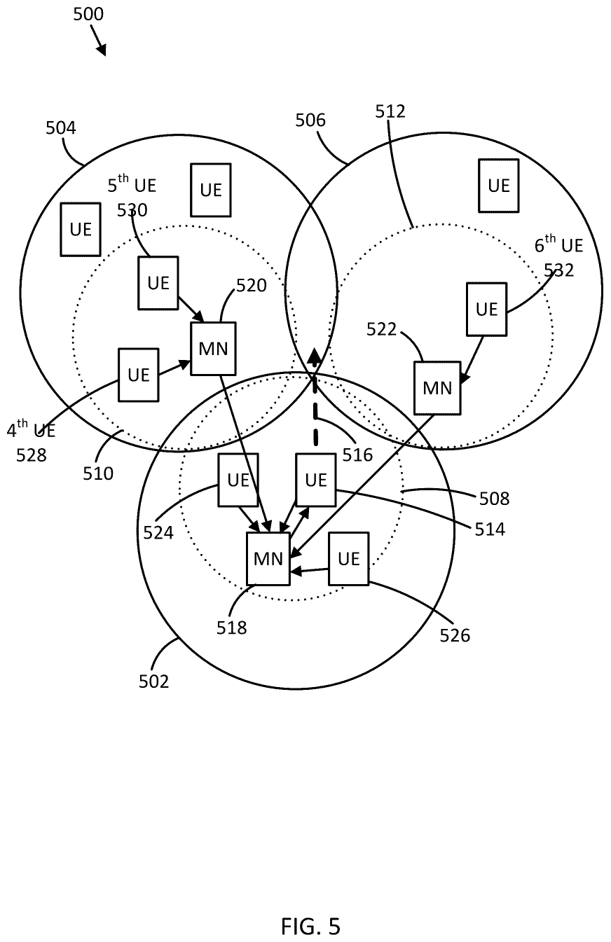

An assumption for the approach is that a subnetwork is established and communication is handled by the MN. The MN of a subnetwork may be a M-UE of the subnetwork. FIG. 5 illustrates an example network arrangement 500 in accordance with some embodiments. The arrangement 500 illustrates an example of an MN-centric approach for HO support.

The arrangement 500 may include one or more cells. In the illustrated embodiment, the arrangement 500 includes a first cell 502, a second cell 504, and a third cell 506, as illustrated by the solid line spheres in the illustrated embodiment. Each of the cells may be hosted by a same base station, different base stations, or some combination thereof. Each of the base stations may include one or more of the features of the gNB 2500 (FIG. 25). As seen in the illustrated arrangement 500, the cells may overlap with one or more other cells.

The arrangement 500 may include one or more subnetworks. In the illustrated embodiment, the arrangement 500 includes a first subnetwork 508, a second subnetwork 510, and a third subnetwork 512, as illustrated by the dotted line spheres in the illustrated embodiment. The subnetworks may be located within cells and can include a portion of the area of the cells. For example, the first subnetwork 508 is located within the first cell 502 in the illustrated embodiment and includes portions of the first cell 502, the second cell 504, and the third cell 506. The second subnetwork 510 is located within the second cell 504 in the illustrated embodiment and includes portions of the first cell 502, the second cell 504, and the third cell 506. The third subnetwork 512 is located within the third cell 506 in the illustrated embodiment and includes portions of the first cell 502, the second cell 504, and the third cell 506.

The arrangement 500 may include one or more UEs. As an example, the arrangement 500 includes a first UE 514. Each of the UEs may include one or more of the features of the UE 2400 (FIG. 24). Each of the UEs may be included in one or more of the cells and/or one or more of the subnetworks. For example, the first UE 514 is located within the first cell 502 and the first subnetwork 508 in the illustrated embodiment. The UEs may be mobile and may move into different cells and/or subnetworks. For example, the first UE 514 may be moving as indicated by the arrow 516 in the illustrated embodiment.

Each of the subnetworks may have a MN. A UE within a subnetwork may be assigned as the MN for the subnetwork. For example, the first subnetwork 508 includes a first MN 518, the second subnetwork 510 includes a second MN 520, and the third subnetwork 512 includes a third MN 522 in the illustrated embodiment.

In an MN-centric approach, UEs may share information (e.g., serving cell identifier (ID), transmission configuration indicator (TCI) state, channel condition, quality of service (QOS) indication, mean scheduling delay, etc.) within the subnetwork and/or between the sub networks, when a UE is approaching the cell edge, to support the mobility decision of the UE. For example, UEs within a subnetwork may share information with an MN of the subnetwork. In the illustrated example, the first UE 514, a second UE 524, and a third UE 526 within the first subnetwork 508 may share information with the first MN 518. A fourth UE 528 and a fifth UE 530 within the second subnetwork 510 may share information with the second MN 520. A sixth UE 532 within the third subnetwork 512 may share information with the third MN 522. Further, the MNs may share information with other MNs. In the illustrated example, the second MN 520 and the third MN 522 may share information with the first MN 518.

The UE may send a request to the MN of the subnetwork to collect supporting information when executing prepared RRC reconfigurations for e.g., conditional handover. For example, the first UE 514 may send a request to the first MN 518 in the illustrated embodiment to collect information for performing an HO when the first UE 514 is approaching an edge of the first cell 502. The first UE 514 may determine that it is approaching an edge of the first cell 502 based on signal measurements of signals from the first cell 502 being below a threshold value, signal measurements of signals from the first cell 502 being below signal measurements of signals from other cells, and/or signals measurements of signals from the first cell 502 being below signal measurements of signals from other cells by a threshold value. The UE request may include target/prepared cell IDs, TCI states, and/or measurements, UE trajectory prediction and predicted target cell IDs and/or TCI states, or some combination thereof.

Upon reception of the request, the MN may send a report about the experience of “relevant” UEs to the requesting UE. For example, the first MN 518 may send a report to the first UE 514 in response to receiving the request for supporting information from the first UE 514. The first MN 518 may determine relevant UEs for the report based on the information included in the request, such as the target/prepared cell IDs, the TCI states, the measurements, the UE trajectory prediction, and/or the predicted target cell IDs. The “relevant” UEs may be determined by the MN based on the trajectory of the requesting UE. For example, the first MN 518 may determine that the first UE 514 is moving toward an area within the second cell 504 and the third cell 506, and/or that the first UE 514 has possible target cells of the second cell 504 and the third cell 506 for an HO in the illustrated embodiment (which both can be determined based on the information from the request). The first MN 518 may determine that UEs within the second cell 504 and the third cell 506 are relevant, which includes the fourth UE 528, the fifth UE 530, and the sixth UE 532 in the illustrated embodiment. The first MN 518 may generate a report that includes information from the fourth UE 528, the fifth UE 530, and the sixth UE 532 in the illustrated embodiment, where the first MN 518 may receive the information for the UEs from the second MN 520 and the third MN 522.

The MN may anonymize and aggregate the experiences of “relevant” UEs before sharing with the UE for privacy reasons. For example, the first MN 518 may anonymize and aggregate the information from the fourth UE 528, the fifth UE 530, and the sixth UE 532 when generating the report and prior to sending the report to the first UE 514. The report can include a table with columns of serving cell ID, TCI state, channel condition, QoS indication, and/or mean scheduling delay.

The MN may collect information from the UEs within the subnetwork periodically or based on specific events, in order to build up this aforementioned experience database. For example, the first MN 518 may collect information from the first UE 514, the second UE 524, the third UE 526, the fourth UE 528, the fifth UE 530, and/or the sixth UE 532 periodically, or based on an occurrence of an event or events. Depending on the subnetwork creation and locations of UEs, the signalling between the MN and the UEs may differ. For example, UEs within a same subnetwork as a requesting MN may directly signal the information to the MN (as illustrated by the first UE 514, the second UE 524, and the third UE 526 directly providing the information to the first MN 518), whereas as UEs within a different subnetwork from the requesting MN may signal the information through an intermediate MN to the requesting MN (as illustrated by the fourth UE 528 and the fifth UE 530 providing the information through the second MN 520 to the first MN 518).

If the subnetwork is created at the intersection of the cells, the MN may contain data about UE experiences in the database and share it with the UE upon request. Otherwise, the MN may need to collect the required information to support mobility decision of the UEs from other MNs.

### Details of Approach—Summary

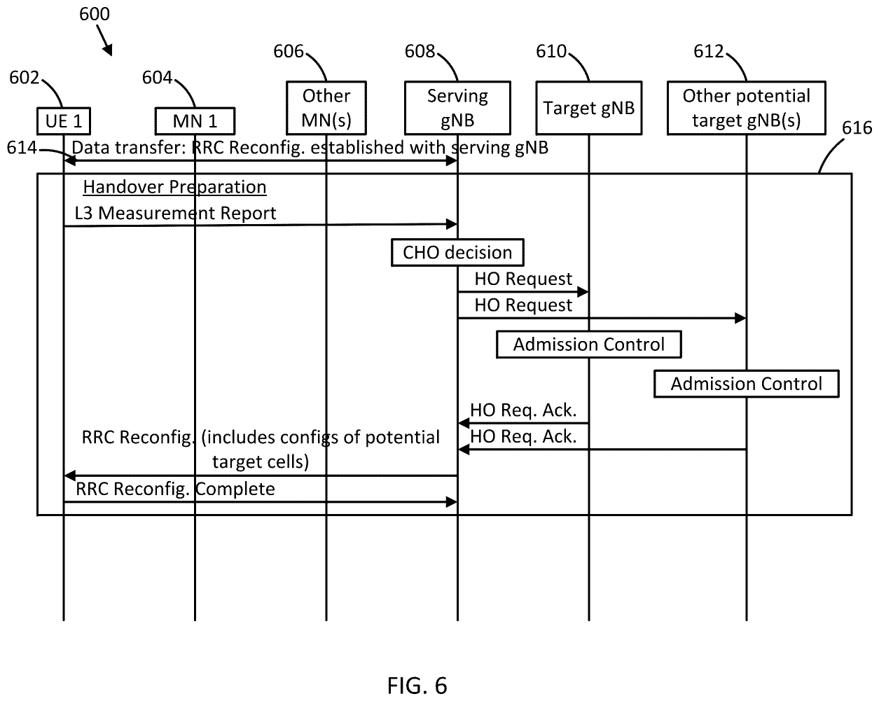

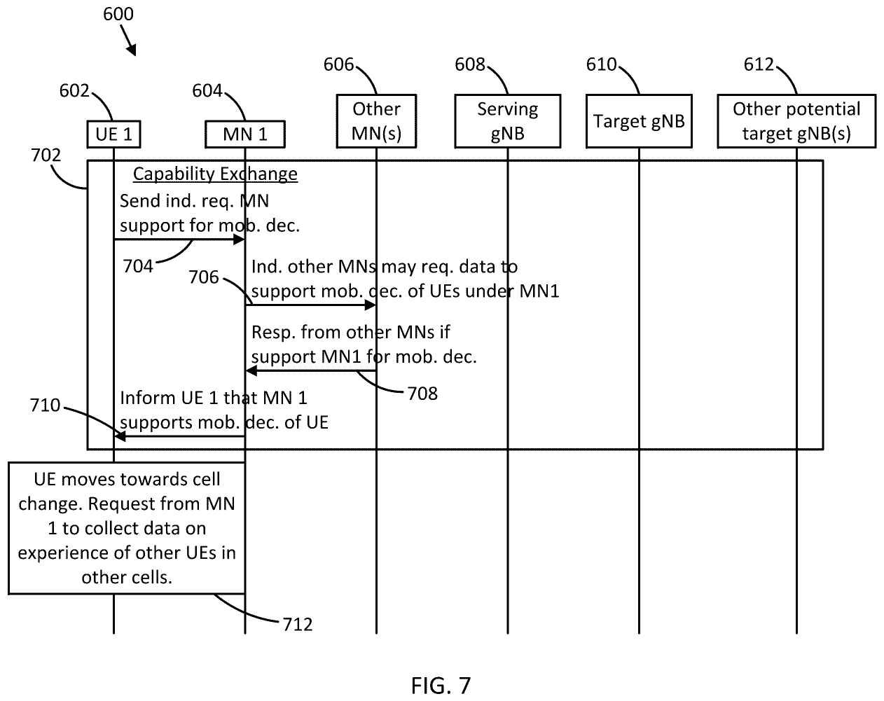

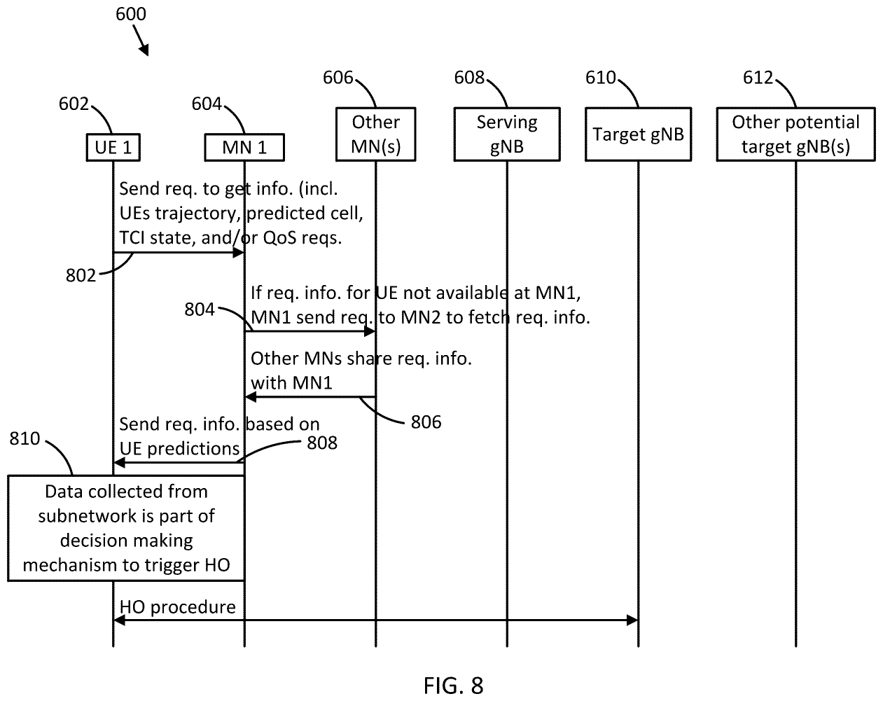

FIG. 6 illustrates a first portion of an example signaling chart 600 for an MN-centric approach in accordance with some embodiments. FIG. 7 illustrates a second portion of the example signaling chart 600 in accordance with some embodiments. FIG. 8 illustrates a third portion of the example signaling chart 600 in accordance with some embodiments. The signaling chart 600 captures the signaling and aspects of the approach.

The signaling chart 600 includes a UE 602. The UE 602 may include one or more of the features of the UE 2400 (FIG. 24). The signaling chart 600 illustrates signaling and aspects that may exist for an MN-centric approach to HO of the UE 602.

The signaling chart 600 includes a first MN 604. The first MN 604 may include one or more of the features of the first MN 518 (FIG. 5), the second MN 520 (FIG. 5), and/or the third MN 522 (FIG. 5). For example, the first MN 604 may be a UE selected to operate as an MN for a subnetwork. The first MN 604 may be within a same subnetwork as the UE 602.

The signaling chart 600 includes one or more other MNs 606. The one or more other MNs 606 may include one or more of the features of the first MN 518 (FIG. 5), the second MN 520 (FIG. 5), and/or the third MN 522 (FIG. 5). For example, each of the MNs within the one or more MNs may be a UE selected to operate as an MN for a corresponding subnetwork. The one or more other MNs 606 may be part of different subnetworks than the UE 602.

The signaling chart 600 includes a serving base station 608. The serving base station 608 may include one or more features of the gNB 2500 (FIG. 25). The serving base station 608 may host one or more cells, such as the first cell 502 (FIG. 5), the second cell 504 (FIG. 5), and/or the third cell 506 (FIG. 5). The UE 602 may have a connection established with the serving base station 608 at the beginning of the signaling chart 600.

The signaling chart 600 includes a target base station 610. The target base station 610 may include one or more features of the gNB 2500 (FIG. 25). The target base station 610 may host one or more cells, such as the first cell 502 (FIG. 5), the second cell 504 (FIG. 5), and/or the third cell 506 (FIG. 5). The target base station 610 may be a potential target base station for an HO of the UE 602 that is ultimately selected for the HO as described throughout the description of the signaling chart 600.

The signaling chart 600 includes one or more other potential target base stations 612. Each of the one or more other potential target base stations 612 may include one or more features of the gNB 2500 (FIG. 25). Each of the one or more other potential target base stations 612 may host one or more cells, such as the first cell 502 (FIG. 5), the second cell 504 (FIG. 5), and/or the third cell 506 (FIG. 5). The one or more other potential target base stations 612 may be potential target base stations for the HO of the UE 602 that are ultimately not selected for the HO as described throughout the description of the signaling chart 600.

The UE 602 may perform a data transfer 614 with the serving base station 608 to have an RRC reconfiguration established with the serving base station 608. The UE performs handover preparation mechanism, as in CHO, to obtain the RRC reconfiguration of the target cells. For example, an HO preparation procedure 616 may be performed for the UE 602. The HO preparation procedure 616 may include one or more of the features of the HO preparation procedure 110 (FIG. 1). The HO preparation procedure 616 may configure the UE 602 with the target base station 610 and the other potential target base stations 612 as potential target base stations for an HO of the UE 602.

Capability exchange is performed with the MN of the subnetwork. For example, a capability exchange procedure 702 is performed for the UE 602. The capability exchange procedure 702 may be performed to indicate whether the first MN 604 supports MN-centric predictive mobility.

The UE 602 may generate and/or transmit an indication 704 that the UE 602 requires MN support for a mobility decision. The indication 704 may request that the first MN 604 indicate whether it supports MN-centric predictive mobility.

The first MN 604 may receive the indication 704. The first MN 604 may generate and/or transmit one or more indications 706, to the one or more other MNs 606, that it may require data to support mobility decisions of the UEs under the first MN 604.

The one or more other MNs 606 may receive the indications 706. The one or more other MNs 606 may generate and/or transmit one or more responses 708, to the first MN 604, that indicates if they want to support the first MN 604 for mobility decisions.

The first MN 604 may receive the responses 708. The first MN 604 may determine whether the one or more other MNs 606 will support the first MN 604 for mobility decisions based on the responses 708. The first MN 604 may generate and/or transmit a response 710 to the UE 602 to indicate whether the first MN 604 supports mobility decisions of the UE. In the illustrated example, the response 710 may indicate that the first MN 604 supports MN-centric predictive mobility for mobility decisions of the UE 602.

The order that the capability exchange and the handover preparation take place in time may change depending on the configurations. For example, an order in which the HO preparation procedure 616 and capability exchange procedure 702 are performed may be different in different embodiments.

After capability exchange, the UE may request data from the MN to support the mobility decision. For example, the UE 602 may determine that it is moving toward a cell change in 712. The UE 602 may determine that it is approaching an edge of the cell of the serving base station 608 to which the UE 602 is currently connected. The UE may determine that it is to request the first MN 604 to collect data on experience of other UEs in other cells. The UE 602 may generate and/or send a request 802 to the first MN 604 to get information for an HO procedure. The UE 602 may generate and/or send the request 802 based on the determination that the UE 602 is approaching the edge of the cell. The request 802 may include UE trajectory, a predicted cell, a TCI state, and/or QoS requirements of the UE.

The first MN 604 may receive the request 802. The first MN 604 may determine potential target base stations for the UE 602 based on the information within the request. In the illustrated embodiment, the first MN 604 may determine that the target base station 610 and the other potential target base stations 612 are potential target base stations for the UE 602. The first MN 604 may determine whether the first MN 604 has the required information to support the mobility decision for the UE 602. In the illustrated embodiment, the first MN 604 may determine whether it has service information for UEs connected to the target base station 610 and service information for UEs connected to the other potential target base stations 612. If the first MN 604 does not have the information, the first MN 604 may generate and/or transmit one or more requests 804 for the information. If the first MN 604 has the information, the one or more requests 804 may be omitted.

The other MNs 606 may receive the requests 804 to fetch the required data. In response to the requests 804, the other MNs 606 may retrieve the required information, and may generate and send one or more responses 806 to the first MN 604 with the requested information.

The first MN 604 may retrieve the requested information from memory and/or the responses 806. The first MN 604 may generate and/or send a response 808 to the UE 602. The response 808 may include the requested information based on UE predictions. The response 808 may include serving cell IDs, TCI states, channel conditions, QoS indications, and/or mean scheduling delay for the UEs within the target cells. In some embodiments, the response 808 may include a serving cell ID for a target base state station to which the HO for the UE 602 is to be performed.

The UE 602 may receive the response 808. The UE 602 may utilize the information from the response 808 at part of a decision making mechanism to trigger the HO. For example, the UE 602 may determine a target base station to which an HO procedure is to be performed. In the illustrated embodiment, the UE 602 may determine that it is to be perform an HO procedure to the target base station 610. Accordingly, the UE 602 and the target base station 610 may perform an HO procedure 812 to transition the connection of the UE 602 from the serving base station 608 to the target base station 610.

Data collection at the MN is describe below with both novel signaling aspects and information elements.

### Flowchart for Decision to Use Predictive Mobility

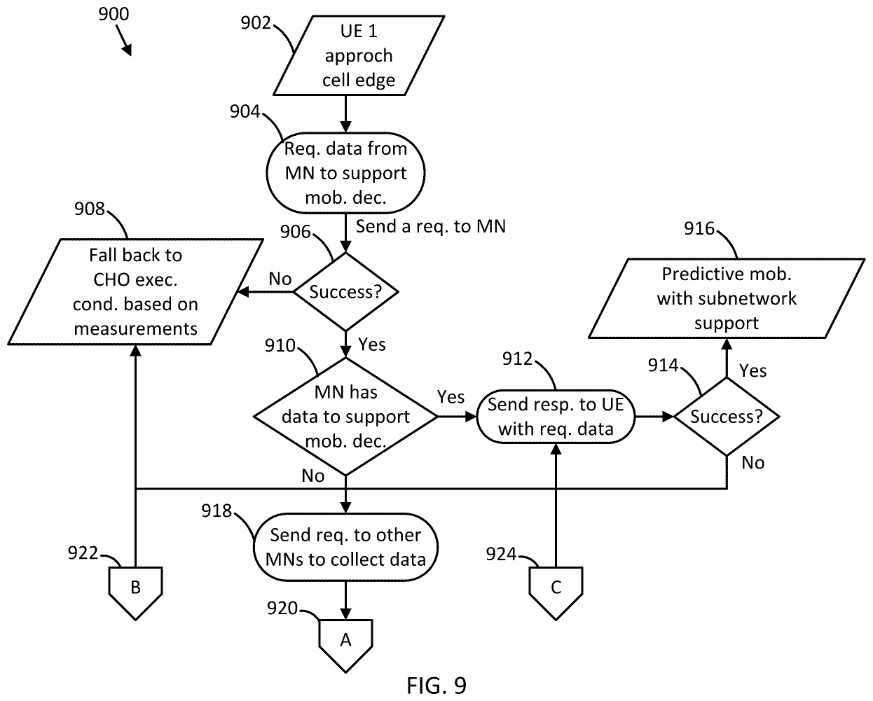

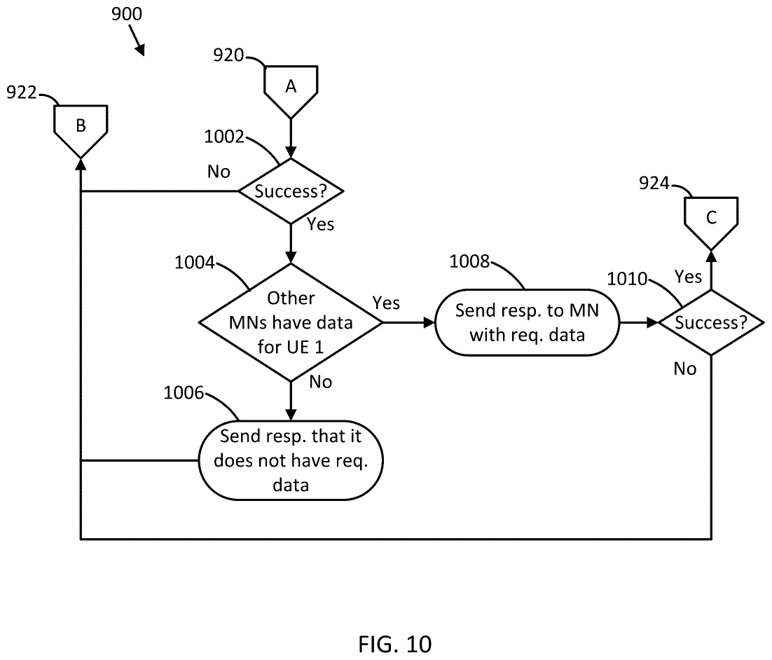

FIG. 9 illustrates a first portion of a flowchart 900 of an example procedure for a decision mechanism at a UE in accordance with some embodiments. FIG. 10 illustrates a second portion of the flowchart 900 in accordance with some embodiments. For example, the flowchart 900 illustrates an example method for decision mechanism at the UE. In more detail, the flowchart describes when to use predictive mobility with subnetwork support or use the legacy approach as a fallback in accordance with some embodiments.

When UE 1 is approaching to the cell edge (e.g. when serving cell signal quality drops a certain threshold) it requests a data from the MN to support the mobility decision. For example, a UE (such as the UE 602 (FIG. 6)) may determine that it is approaching an edge of a cell to which it is connected in 902.

In 904, the UE may request data from an MN (such as the first MN 604 (FIG. 6)) to support a mobility decision of the UE. For example, the UE may generate a request for the data. The UE may transmit the request to the MN.

In 906, it can be determined whether the request was successfully delivered to the MN. If the message is not successfully sent to the MN, meaning that the signal quality between MN and UE is not good enough for data exchange, UE 1 falls back to CHO execution condition on signal measurements. For example, if the request was determined not to be successfully delivered to the MN, the procedure may proceed to 908, where the UE falls back to the CHO execution condition based on measurements of the UE. If UE 1 does not receive a response back from the MN within a certain time, it falls back to the conditional handover based on signal measurements. For example, if the UE does not receive a response back from the MN within a certain time period, the UE may determine that the request was not successfully delivered (or the procedure failed at some other point) and the procedure may proceed to 908. If the request was successfully delivered to the MN, the procedure may proceed to 910.

If the message is successfully sent to the MN, the MN checks if it has data to support the mobility decision of the UE 1. In 910, the MN may determine whether it has the data to support the mobility decision of the UE.

If yes, then it sends a response to UE 1 with requested data. For example, if the MN has the data to support the mobility decision of the UE, the MN may send a response to the UE in 912 that includes the requested data. In 914, it may be determined whether the response is received by the UE. If the message is received successfully, UE 1 uses this information in its handover execution condition. For example, if the response is successfully received by the UE, the procedure may proceed to 916, where the UE performs an HO operation with predictive mobility with subnetwork support. If the message is not received, UE 1 falls back to CHO execution with signal measurements. For example, the procedure may proceed to 908 if the response is not received by the UE, where the UE falls back to the CHO execution condition based on measurements of the UE.

If the MN does not have the data, the MN tries to contact other MNs in the vicinity by sending a request. For example, the procedure may proceed from 910 to 918 if the MN does not have the data requested by the UE for the HO operation. In 918, the MN may send one or more requests to other MNs to collect the requested data.

The procedure may proceed from 918 to 920 of FIG. 9. 920 of FIG. 9 may proceed to 920 of FIG. 10. The procedure may proceed from 920 of FIGS. 10 to 1002. In 1002, it is determined whether the requests sent from the MN to the other MNs were successfully sent. If it is determined that the requests were not successfully sent to the other MNs, the procedure may proceed to 922 and 908, where the UE falls back to the CHO execution condition based on measurements of the UE. If it is determined that the requests were successfully sent to the other MNs, the procedure may proceed to 1004.

In 1004, the other MNs may determine whether they have the data for UE, as requested by the MN. If the other MNs do not have the requested data, the procedure may proceed to 1006. In 1006, the other MNs may send a response to the MN that indicates that the other MNs does not have the requested data. The procedure may proceed from 1006 to 922 and 908, where the UE falls back to the CHO execution condition based on measurements of the UE.

If other MNs have data that can support the mobility decision of UE 1, they share it with the MN, which in turn shares it with UE 1. For example, if the other MNs have the requested data, the procedure may proceed to 1008, where the other MNs send a response to the MN with the requested data. In 1010, it can be determined whether the responses sent by the other MNs were successfully received by the MN. If the responses were not successfully received by the MN, the procedure may proceed to 922 and 908, where the UE falls back to the CHO execution condition based on measurements of the UE. If the response were successfully received by the MN, the procedure may proceed to 924 and 912, where the MN sends a response to the UE with the requested data. In 914, it may be determined whether the response was successfully received and the procedure may proceed accordingly.

### Data Collection and Exchange—Configuration Setup

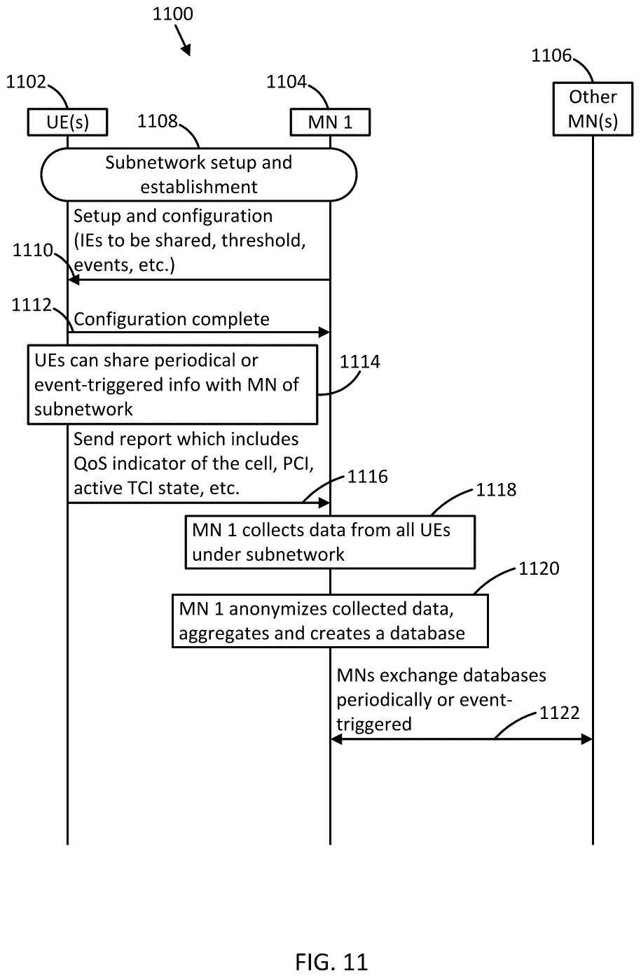

FIG. 11 illustrates a signaling chart 1100 for example data collection and exchange in accordance with some embodiments. For example, the signaling chart 1100 illustrates data collection by an MN from a UE, and exchange of the collected data with other MNs in accordance with some embodiments.

The signaling chart 1100 includes one or more UEs 1102. The UEs 1102 may include one or more of the features of the UE 2400 (FIG. 24).

The signaling chart 1100 includes a first MN 1104. The first MN 1104 may include one or more of the features of the first MN 604 (FIG. 6) and/or the other MNs 606 (FIG. 6). The first MN 1104 may be in a same subnetwork as the one or more UEs 1102.

The signaling chart 1100 includes one or more other MNs 1106. The other MNs 1106 nay include one or more of the features of the first MN 604 (FIG. 6) and/or the other MNs 606 (FIG. 6). The other MNs 1106 may be in a different subnetwork from the UEs 1102 and the first MN 1104.

Subnetwork is established between the UEs and the MN of the subnetwork is selected. For example, a subnetwork is setup and established that includes the UEs 1102 and the first MN 1104 in 1108.

In 1110, MN 1 sends configuration to all UEs for what and how to report using broadcasted system information block (SIB) message through physical downlink shared channel (PDSCH). For example, the first MN 1104 may setup and configure the UEs 1102 in 1110. The configuration can include which information elements (IEs) are to be shared. The information elements may include QoS indicator, cell ID, active beam (i.e., TCI state), channel condition, mean scheduling delay, downlink (DL)/uplink (UL) load information. The UEs 1102 may use the QoS indicator values defined in TS 23.501 Section 5.7.4 or follow the approach of calculation indicated by the MN. For example, QoS indicator calculation may be observed QoS in terms of throughput and latency can be normalized with QoS requirements. Events for reporting may be periodical or conditional based on a threshold. For example, when the reporting is condition, the reporting may be if QoS indication changes between the last report by “threshold” (e.g., can be set by the MN).

In 1112, the UEs may send “configuration complete” messages to indicate that they confirm data sharing with the MNs.

1114 and 1116 may directed to the sharing of data from the UEs 1102 to the first MN 1104. The UEs 1102 may send a quality of experience (QoE) report to the first MN 1104 through PUSCH with dedicated messages, including current and predicted QoS indicator of the serving base station, current serving base station ID, active TCI state and channel condition, mean scheduling delay, and/or load information.

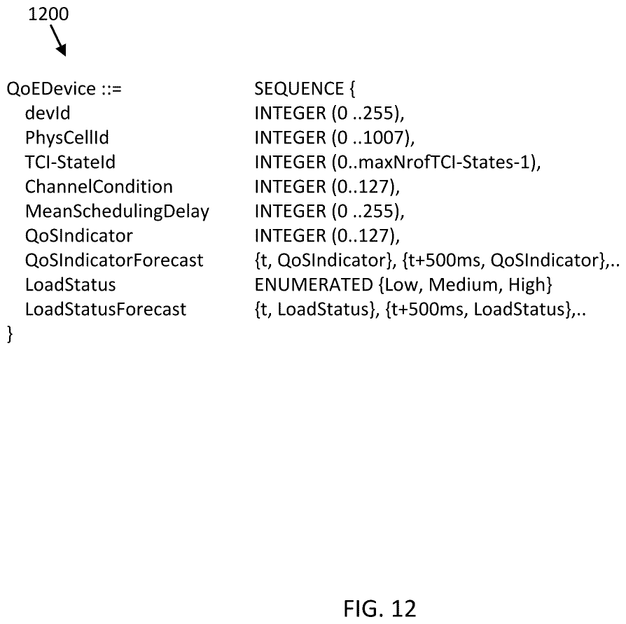

An example information element, QoEDevice, is illustrated. In particular, FIG. 12 illustrates an example QoEDevice information element 1200 in accordance with some embodiments. The QoEDevice information element 1200 can be generated and provided by the UEs 1102 to the first MN 1104 as part of 1114 and 1116.

The QoEDevice information element 1200 may include a device ID (devId) field, a physical cell ID (PhysCellId) field, a TCI state ID (TCI-StateId) field, a channel condition (ChannelCondition) field, a mean scheduling delay (MeanSchedulingDelay) field, a QoS indicator (QoSIndicator) field, a QoS indicator forecast (QoSIndicatorForecast) field, a load status (LoadStatus) field, and/or a load status forecast (LoadStatusForecast) field. The PhysCellId and TCI-StateId may be defined in TS 38.331 (3^{rd} Generation Partnership Project; Technical Specification Group Radio Access Network; NR; Radio Resource Control (RRC) protocol specification. 3GPP TS 38.331, 17.6.0 (2023-09-28)). Channel condition may be indicated via signal interference to noise ratio (SINR) measurement of the serving cell and TCI state, sent through SINR-Range IE defined in TS 38.331. MeanSchedulingDelay may be computed by the UE based on averaged time difference between scheduling request and UL transmission time indicated in the UL grant. This value may be mapped to the integer value. The granularity and the thresholds based on e.g., throughput for load status information may be set by the MN.

### MN Data Processing

The MN collects information from various UEs within the subnetwork about their QoS. For example, the first MN 1104 may collect the data from all of the UEs 1102 that are under the same subnetwork as the first MN 1104 in 1118, received in the reports 1116. The MNs anonymize the collected data and create a database about the experiences of the UEs in the subnetwork. For example, the first MN 1104 may anonymize the collected data and create a database of the data in 1120 The anonymization algorithm is up to MN implementation. A simple average is to average the collected information from various UEs. For example, QoESubnet::=SEQUENCE (1 . . . numDevices) OF QoEDevice. The output of this operation may be the aggregated and anonymized QoE in terms of channel condition, mean scheduling delay, QoS indicator, and/or load status per Cell and TCI state. For example, each MN may keep a database of these aggregated values.

### MN Data Exchange

The MNs may exchange their database with the other MNs. For example, the first MN 1104 and the other MNs 1106 may exchange databases in 1122. The database exchange can be periodic or on-demand (e.g., upon receiving a request from a UE in a subnetwork).

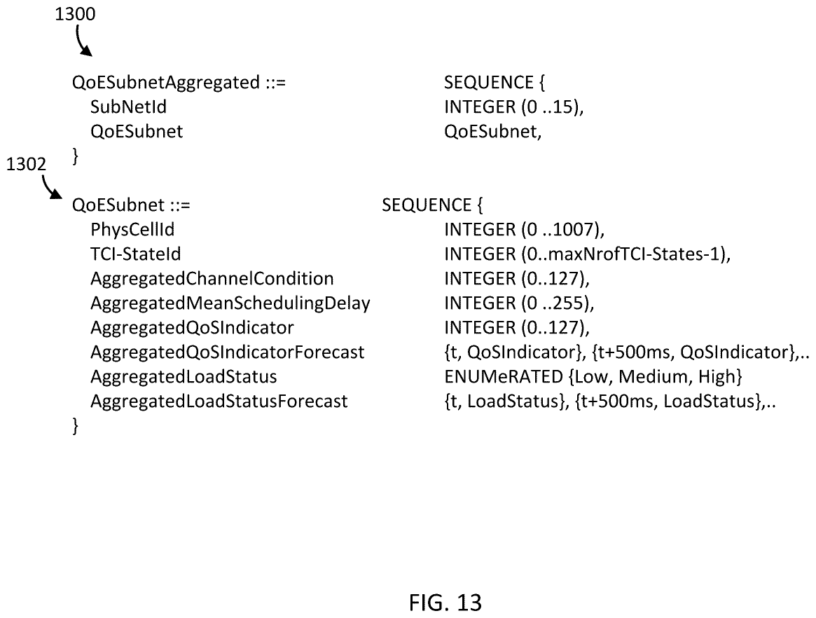

For periodic data exchange, a QoESubnetAggregated IE may be broadcast. The QoESubnetAggregated IE may include a QoESubnet IE. FIG. 13 illustrates an example QoESubnetAggregated IE 1300 and an example QoESubnet IE 1302 in accordance with some embodiments. QoESubnetAggregated may be broadcast periodically to the other MNs through a dedicated SIB via downlink shared channel (DL-SCH).

The MN may add its own subnetwork ID to the message. For example, the QoESubnetAggregated IE 1300 may include a subnetwork ID (SubNetId) field corresponding to the MN that generates the QoESubnetAggregated IE 1300. For example, the first MN 1104 and the other MNs 1106 may exchange messages with the QoESubnetAggregated IEs having the databases and the subnetwork ID of the corresponding MN that generated the QoESubnetAggregated IEs. For on-demand data exchange, the MN may send a unicast SIB via DL-SCH upon request from another MNs and shares QoESubnetAggregated IE.

The QoESubnetAggregated IE 1300 may include the SubNetId field and a QoESubnet field. The QoESubnet field may indicate a QoESubnet IE, such as the QoESubnet IE. The QoESubnet IE may include a PhysCellId field, a TCI-StateId field, an AggregatedChannelCondition field, an AggregatedMeanSchedulingDelay field, an AggregatedQoSIndicator field, an AggregatedQoSIndicatorForecast field, an AggregatedLoadStatus field, and/or an AggregatedLoadStatusForecast field.

Upon reception, the MNs update their database with the received information. For example, the first MN 1104 may update its database with the information from the databases received from the other MNs 1106, and the other MNs 1106 may update their databases with the information the database received from the first MN 1104. The communication between MNs may use different protocols e.g. Wifi Direct, device to device (D2D), Sidelink.

### Details of MN-Centric Approach

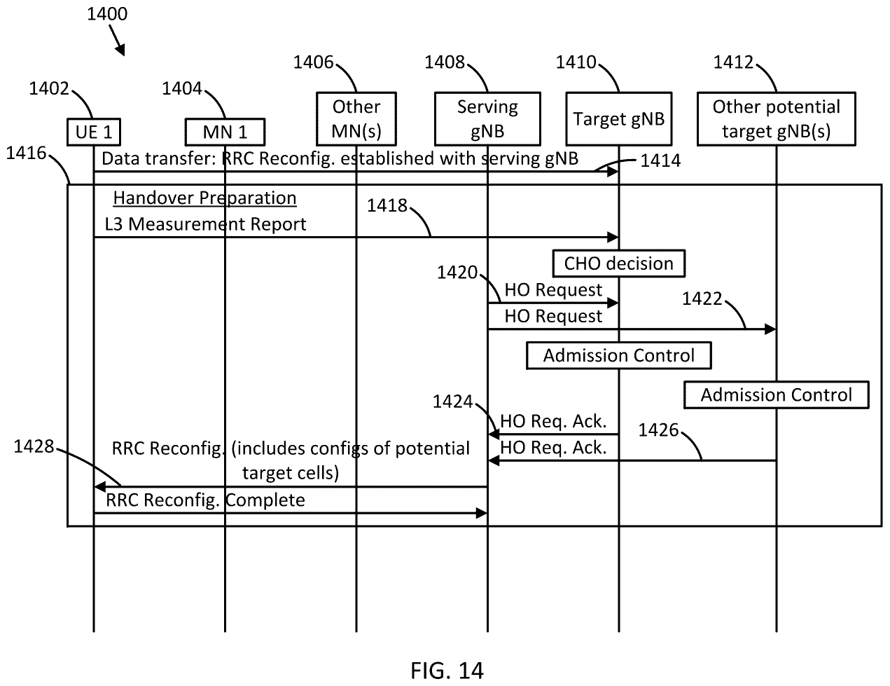

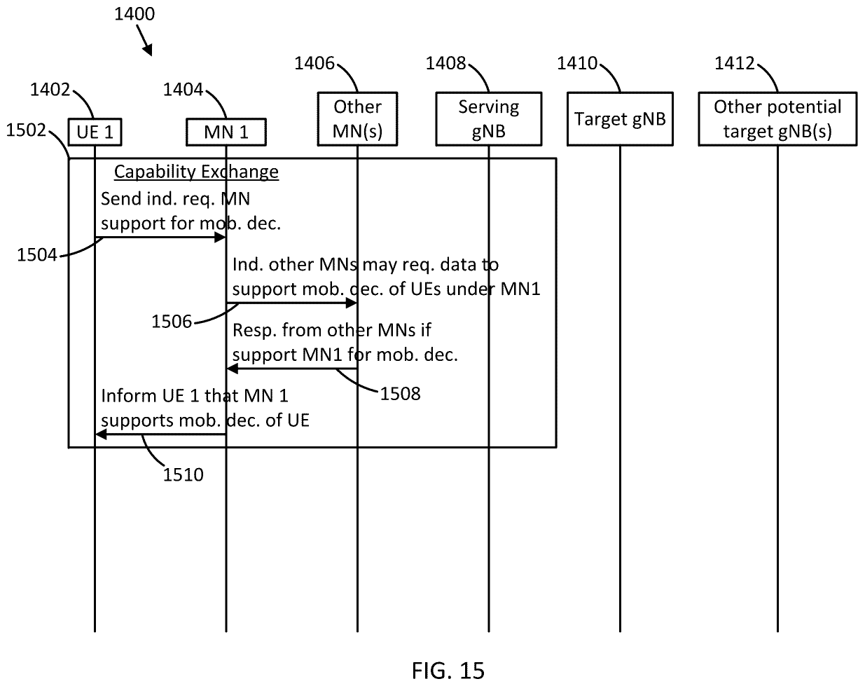

FIG. 14 illustrates a first portion of an example signaling chart 1400 for an MN-centric approach in accordance with some embodiments. FIG. 15 illustrates a second portion of the example signaling chart 1400 in accordance with some embodiments.

The signaling chart 1400 includes a UE 1402. The UE 1402 may include one or more of the features of the UE 2400 (FIG. 24). The signaling chart 1400 illustrates signaling and aspects that may exist for an MN-centric approach to HO of the UE 1402.

The signaling chart 1400 includes a first MN 1404. The first MN 1404 may include one or more of the features of the first MN 518 (FIG. 5), the second MN 520 (FIG. 5), and/or the third MN 522 (FIG. 5). For example, the first MN 1404 may be a UE selected to operate as an MN for a subnetwork. The first MN 1404 may be within a same subnetwork as the UE 1402.

The signaling chart 1400 includes one or more other MNs 1406. The one or more other MNs 1406 may include one or more of the features of the first MN 518 (FIG. 5), the second MN 520 (FIG. 5), and/or the third MN 522 (FIG. 5). For example, each of the MNs within the one or more MNs may be a UE selected to operate as an MN for a corresponding subnetwork. The one or more other MNs 1406 may be part of different subnetworks than the UE 1402.

The signaling chart 1400 includes a serving base station 1408. The serving base station 1408 may include one or more features of the gNB 2500 (FIG. 25). The serving base station 1408 may host one or more cells, such as the first cell 502 (FIG. 5), the second cell 504 (FIG. 5), and/or the third cell 506 (FIG. 5). The UE 1402 may have a connection established with the serving base station 1408 at the beginning of the signaling chart 1400.

The signaling chart 1400 includes a target base station 1410. The target base station 1410 may include one or more features of the gNB 2500 (FIG. 25). The target base station 1410 may host one or more cells, such as the first cell 502 (FIG. 5), the second cell 504 (FIG. 5), and/or the third cell 506 (FIG. 5). The target base station 1410 may be a potential target base station for an HO of the UE 1402 that is ultimately selected for the HO as described throughout the description of the signaling chart 1400.

The signaling chart 1400 includes one or more other potential target base stations 1412. Each of the one or more other potential target base stations 1412 may include one or more features of the gNB 2500 (FIG. 25). Each of the one or more other potential target base stations 1412 may host one or more cells, such as the first cell 502 (FIG. 5), the second cell 504 (FIG. 5), and/or the third cell 506 (FIG. 5). The one or more other potential target base stations 1412 may be potential target base stations for the HO of the UE 1402 that are ultimately not selected for the HO as described throughout the description of the signaling chart 1400.

In 1414, the UE 1402 may be connected to the serving base station 1408. An HO preparation procedure 1416 may be performed for the UE 1402. The HO preparation procedure 1416 may include one or more of the features of the HO preparation procedure 616 (FIG. 6).

In 1418, the UE 1402 may send a measurement report to the serving base station 1408 in order to trigger handover preparation.

In 1420, 1422, 1424, and 1426, the serving base station 1408 may prepare potential gNB candidates for the UE 1402 for conditional handover. For example, the serving base station 1408 may prepare the target base station 1410 and the other potential target base stations 1412 for the UE 1402 for CHO in the illustrated embodiment.

In 1428, the serving base station 1408 may send configuration of the prepared cells. For example, the serving base station 1408 may configure the UE 1402 for the target base station 1410 and the other potential target base stations 1412 as potential target base stations for CHO of the UE 1402.

A capability exchange procedure may be performed between UEs and MNs. For example, a capability exchange procedure 1502 may be performed among the UE 1402, the first MN 1404 and the other MNs 1406.

The UEs exchange their capability with their MN, indicating that they require subnetwork support for mobility decision. For example, the UE 1402 may exchange its capability with the with the first MN 1404 in 1504. The UEs may indicate to the MN the prepared cells for handover. For example, the UE 1402 may indicate to the first MN 1404 that the target base station 1410 and the other potential target base stations have been prepared for HO in 1504. The UEs may indicate which information elements they require for mobility decisions. For example, the UE 1402 may indicate to the first MN 1404 the IEs required for mobility decisions of the UE 1402 in 1504. The IEs may vary depending on the model of the UE for mobility decisions.

MN 1 sends a request to other MNs indicating that MN 1 requires information from the UEs in other MNs. For example, the first MN 1404 may send a request to the other MNs 1406 that indicates information required from the UEs in the same subnetwork as the other MNs 1406 in 1506. If a UE provided the list of prepared cells, MN 1 can use this information to trigger only the MNs in the vicinity of those cells. For example, the first MN 1404 may provide 1506 to MNs within prepared cells indicated by the UE in 1504.

In 1508, responses from the other MNs indicating whether they will support MN 1 for mobility decisions. For example, the other MNs 1406 may transmit responses to the first MN 1404 in 1508 to indicate whether the other MNs 1406 will support the first MN 1404 for mobility decisions.

In 1510, inform UE 1 that MN 1 shall support with data for mobility decision. For example, the first MN 1404 may inform the UE 1402 that the first MN 1404 supports providing data to the UE 1402 for mobility decisions.

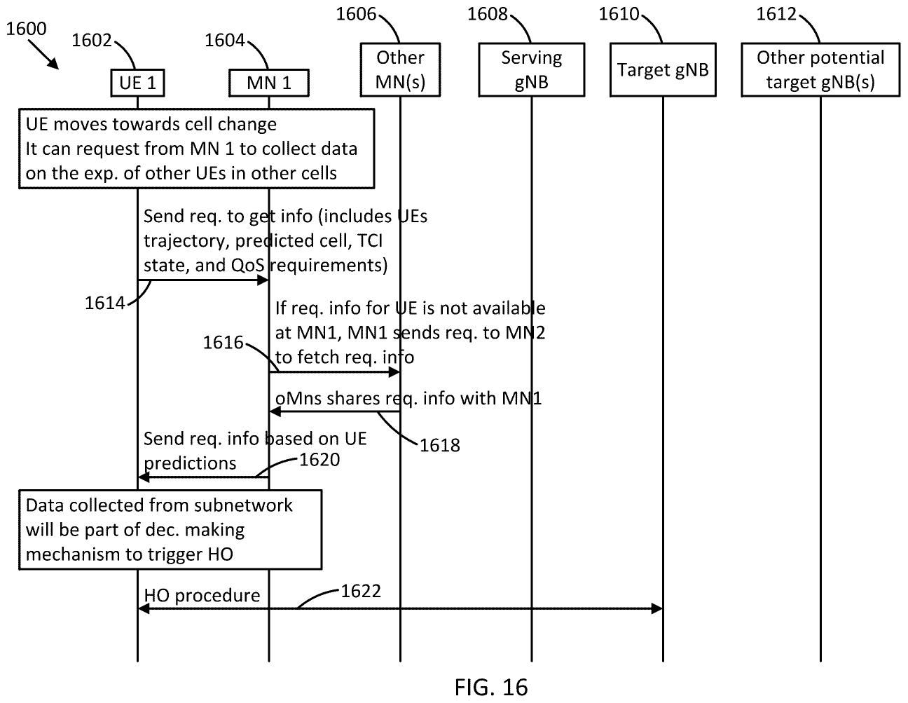

FIG. 16 illustrates an example signaling chart 1600 of an example HO setup and procedure in accordance with some embodiments. The example HO setup and procedure illustrated by the signaling chart 1600 may be after the UE is configured with the RRC reconfiguration of the potential target cells and has performed capability exchange with the MN of the subnetwork.

The signaling chart 1600 includes a UE 1602. The UE 1602 may include one or more of the features of the UE 2400 (FIG. 24). The signaling chart 1600 illustrates signaling and aspects that may exist for an MN-centric approach to HO of the UE 1602.

The signaling chart 1600 includes a first MN 1604. The first MN 1604 may include one or more of the features of the first MN 518 (FIG. 5), the second MN 520 (FIG. 5), and/or the third MN 522 (FIG. 5). For example, the first MN 1604 may be a UE selected to operate as an MN for a subnetwork. The first MN 1604 may be within a same subnetwork as the UE 1602.

The signaling chart 1600 includes one or more other MNs 1606. The one or more other MNs 1606 may include one or more of the features of the first MN 518 (FIG. 5), the second MN 520 (FIG. 5), and/or the third MN 522 (FIG. 5). For example, each of the MNs within the one or more MNs may be a UE selected to operate as an MN for a corresponding subnetwork. The one or more other MNs 1606 may be part of different subnetworks than the UE 1602.

The signaling chart 1600 includes a serving base station 1608. The serving base station 1608 may include one or more features of the gNB 2500 (FIG. 25). The serving base station 1608 may host one or more cells, such as the first cell 502 (FIG. 5), the second cell 504 (FIG. 5), and/or the third cell 506 (FIG. 5). The UE 1602 may have a connection established with the serving base station 1608 at the beginning of the signaling chart 1600.

The signaling chart 1600 includes a target base station 1610. The target base station 1610 may include one or more features of the gNB 2500 (FIG. 25). The target base station 1610 may host one or more cells, such as the first cell 502 (FIG. 5), the second cell 504 (FIG. 5), and/or the third cell 506 (FIG. 5). The target base station 1610 may be a potential target base station for an HO of the UE 1602 that is ultimately selected for the HO as described throughout the description of the signaling chart 1600.

The signaling chart 1600 includes one or more other potential target base stations 1612. Each of the one or more other potential target base stations 1612 may include one or more features of the gNB 2500 (FIG. 25). Each of the one or more other potential target base stations 1612 may host one or more cells, such as the first cell 502 (FIG. 5), the second cell 504 (FIG. 5), and/or the third cell 506 (FIG. 5). The one or more other potential target base stations 1612 may be potential target base stations for the HO of the UE 1602 that are ultimately not selected for the HO as described throughout the description of the signaling chart 1600.

The UE is moving towards the edge of serving gNB coverage and observes the target gNBs. The UE needs to decide the best target gNB or gNBs for initiating the conditional handover procedure.

The UE sends a request to MN of the subnetwork it is connected to, in order to collect information about the experience of the UEs in the potential target gNBs via PUSCH. For example, the UE 1602 may send a request to the first MN 1604 in 1614 via PUSCH. The request may request information about the experience of UEs within the target base station 1610 and UEs within the other potential target base stations 1612. The configuration of when to send a request can be configured by the first MN 1604 during capability exchange or it can be UE implementation-specific.

The UE request transmitted in 1614 may include a target/prepared cell IDs, TCI states, and/or measurements in some embodiments. The first MN 1604 may configure the UE 1602 to include target/prepared cell IDs/TCI states, whose measurements are higher than a certain threshold. In that case, the UE may not need to include measurements e.g. reference signal received power (RSRP), reference signal received quality (RSRQ), and SINR. In some embodiments, the UE request transmitted in 1614 may include the UE trajectory prediction and predicted target cell IDs, TCI states, and/or measurements.

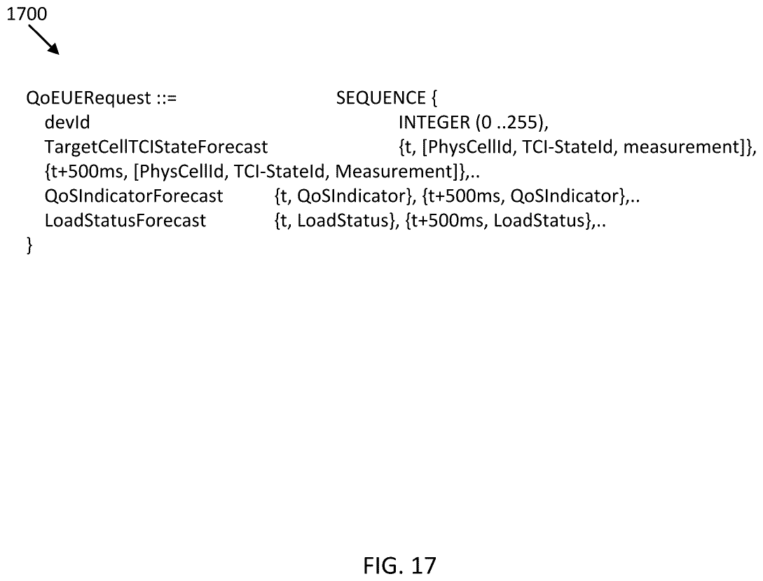

FIG. 17 illustrates an example of an IE 1700 sent by the UE 1602 during request via PUSCH in accordance with some embodiments. For example, the IE 1700 may be sent from the UE 1602 to the first MN 1604 in 1614. The IE 1700 may be a QoUUERequest IE. The IE 1700 may include a devId field, a TargetCellTCIStateForecast field, a QoSIndicatorForecast field, and/or a LoadStatusForecast field.

Upon reception of a request from UE 1, MN 1 checks its database if it has information about the QoE from other UEs of the forecasted [Cells, TCI Stated], indicated in the request. For example, the first MN 1604 may check its stored database to determine if the first MN 1604 has the requested information upon reception of the request 1614 from the UE 1602

If the required information for the UE is not available at MN1 (for example, UE may aim to connect to target gNB B, but MN1 does not have information about UEs connected to gNB B), the MN 1 may send a request to other MNs to fetch the requested information. For example, if the first MN 1604 determines that it does not have the information requested by the UE 1602, the first MN 1604 may send one or more requests to the other MNs 1606 for the information in 1616. The request of MN 1 may be broadcast through a dedicated SIB via downlink shared channel (DLSCH), or using Wifi Direct or a D2D link.

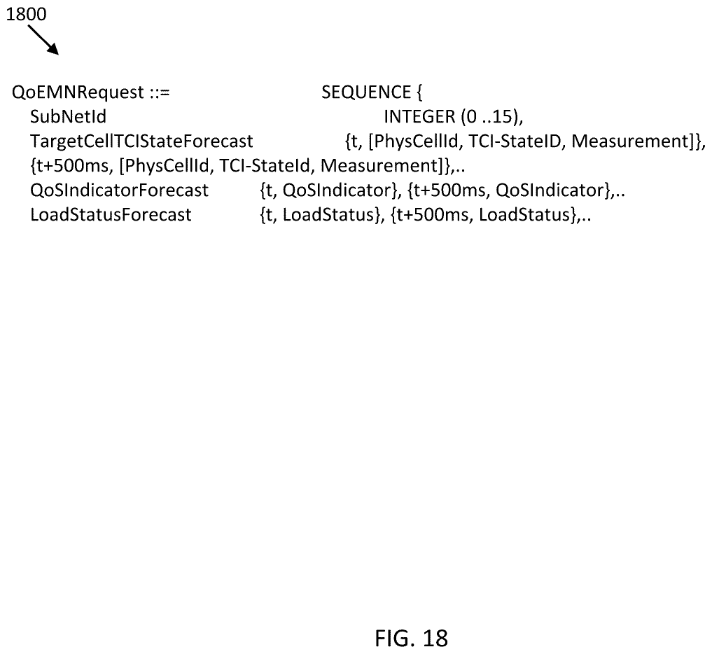

FIG. 18 illustrates an example IE 1800 in accordance with some embodiments. MN 1 may share the IEs with the other MNs. For example, the first MN 1604 may share the IE 1800 with the other MNs 1606. The IE 1800 may be a QoEMNRequest IE. The IE 1800 may include a SubNetId field, a TargetCellTCIStateForecast field, a QoSIndicatorForecast field, and/or a LoadStatusForecast field.

Upon reception of the request from MN, other MNs check in their database whether they have information about the target cells and TCI states indicated in the MN request. If they have the requested information, these MN(s) share the requested information with MN 1. For example, the other MNs 1606 may check if they have the requested information in their databases upon reception of the request from the first MN 1604 in 1616. If the other MNs 1606 have the information, the other MNs 1606 may provide the information to the first MN 1604 in 1618. The information may include the connectivity experience of the MN's served UEs, in terms of QoS that are served by the potential target gNBs/TCI states of the UE 1. For example, the information may include connectivity experience of UEs served by the target base station 1610 and UEs served by the other potential target base stations 1612 within the same subnetworks as the other MNs 1606 that have the TCI states indicated by the UE 1602. The response may include the QoESubnetAggregated IE 1300 (FIG. 13).

Upon reception of the request, the MN sends a report about the experience of “relevant” UEs to UE 1 via a unicast SIB with DL-SCH. For example, the first MN 1604 may determine relevant UEs based on predicted base stations and/or predicted trajectory of the UE 1602 indicated in the request of 1614. The first MN 1604 may generate a report including the information from the determined relevant UEs and/or indications based on the information from the determined relevant UEs. The first MN 1604 may provide the report to the UE 1602 in 1620. The experience of the “relevant” UEs may be aggregated and anonymized by the MNs. For example, the first MN 1604 may aggregate and anonymize the information included in the report provided in 1620.

The “relevant” UEs may be determined by the MN based on the trajectory of the requesting UE 1. For example, if a UE 1 is expected to be in the coverage of the [cell A, TCI state 1] at time t (current time)+K, the other UEs served by [cell A, TCI state 1] are “relevant” for the UE 1.

The response may include the IE QoEAggregatedUEs where, DevId is the unique id of the UE 1 in the subnetwork that sent a request for data collection. The QoESubnet includes the aggregated experiences of the UEs served by the certain cells and TCI states. For example, the response transmitted in 1620 may include the QoESubnetAggregated IE 1300 (FIG. 13), where the QoESubnet IE 1302 (FIG. 13) may include the aggregated experiences of the relevant UEs.

UE 1 can use the information shared by the network to decide the target cell. It can initiate handover to a gNB that it expects to satisfy its QoS requirements. For example, the UE 1602 may determine a target cell for an HO procedure based on the information received from the first MN 1604 in 1620. In the illustrated embodiment, the UE 1602 may determine that the HO procedure is to be performed to the target base station 1610. The UE 1602 may initiate an HO procedure in 1622 to the target base station 1610.

In another embodiment, at 1620, the first MN 1604 does not share the table that includes the experiences of the “relevant” UEs. Instead, the first MN 1604 may just send to UE 1602 the cell ID of the best cell, the best cell determined based on the aggregated experiences of other UEs.

### Direct UE-to-UE Communication

For a direct UE-to-UE communication approach, an assumption is made that the UE can directly communicate with other UEs with D2D connection in a secured channel (e.g., ciphered messages). Discovery may be performed to discover the other UEs. Other UEs are trusted (the trust criteria are not in the scope of this invention).

When a UE is approaching the cell edge (e.g., serving cell signal quality degrades), it can send a request to neighboring UEs directly. In some embodiments, a broadcast message including a request for information may be transmitted via a SIB with PUSCH. In some embodiments, a unicast message including a request may be transmitted if the UEs are discovered and the serving cell and TCI state are known to UE 1.

The UE request can include target/prepared cell IDs and/or TCI states in some embodiments. In some embodiments, the UE request can include UE trajectory prediction and predicted target cell IDs, and/or TCI states. There may be various conditions for a UE to send a response. For example, only the UEs that are on the trajectory of the requesting UE report back in some embodiments.

Neighboring UE response may include serving cell ID, TCI state, channel condition, QoS Indication, and/or mean scheduling delay. Upon reception of a response, UE 1 considers the experience of neighboring UEs for handover decision.

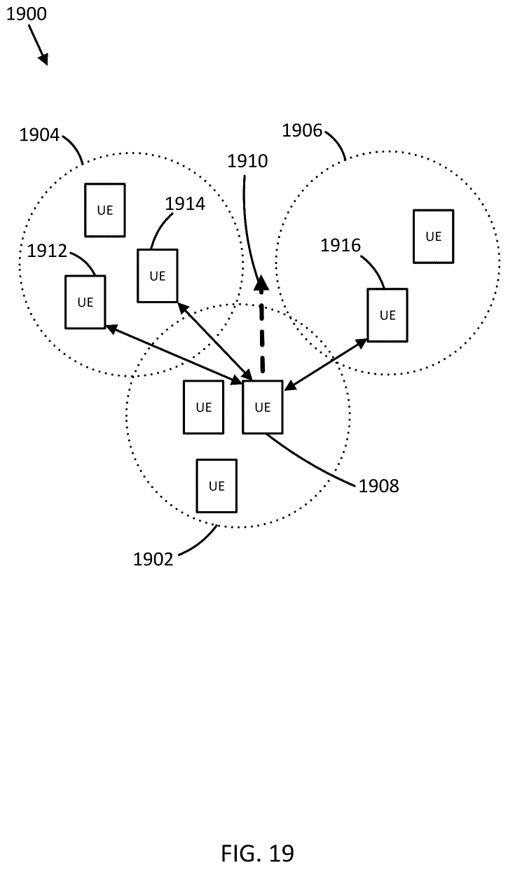

FIG. 19 illustrates an example network arrangement 1900 in accordance with some embodiments. The arrangement 1900 illustrates an example of a direct UE-to-UE communication approach for HO support.

The arrangement 1900 may include one or more cells. In the illustrated embodiment, the arrangement 1900 includes a first cell 1902, a second cell 1904, and a third cell 1906, as illustrated by the dotted line spheres in the illustrated embodiment. Each of the cells may be hosted by a same base station, different base stations, or some combination thereof. Each of the base stations may include one or more of the features of the gNB 2500 (FIG. 25). As seen in the illustrated arrangement 1900, the cells may overlap with one or more other cells.

The arrangement 1900 may include one or more UEs. As an example, the arrangement 1900 includes a first UE 1908. Each of the UEs may include one or more of the features of the UE 2400 (FIG. 24). Each of the UEs may be included in one or more of the cells. For example, the first UE 1908 is located within the first cell 1902 in the illustrated embodiment. The UEs may be mobile and may move into different cells and/or subnetworks. For example, the first UE 1908 may be moving as indicated by the arrow 1910 in the illustrated embodiment.

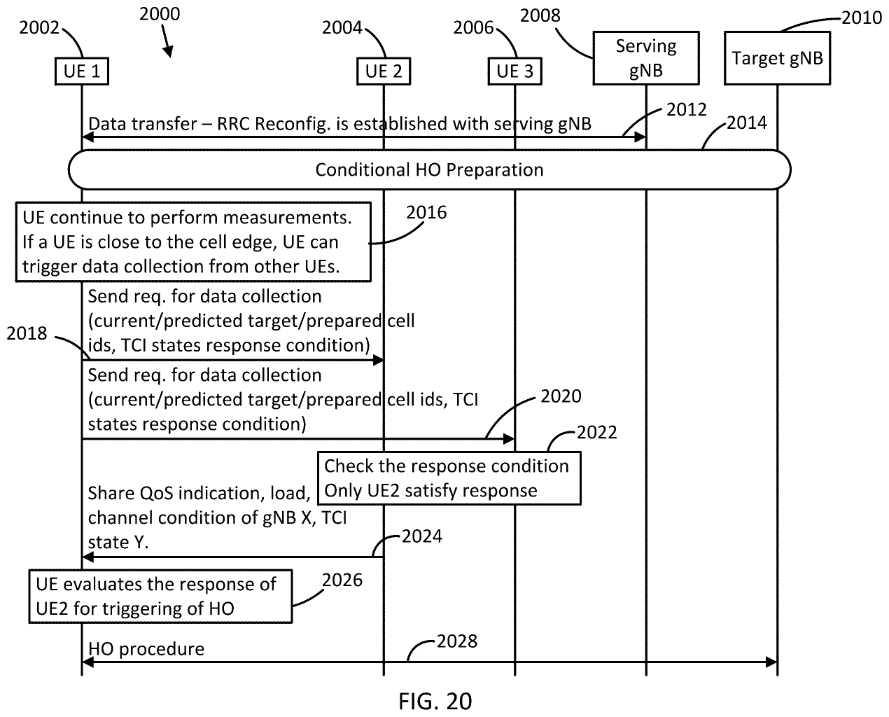

In the direct UE-to-UE communication approach, the UEs may communicate with other relevant UEs to obtain information for an HO decision. For example, the first UE 1908 may communicate with a second UE 1912, a third UE 1914, and a fourth UE 1916 in the illustrated embodiment. The UEs may exchange messages as described further in relation to FIG. 20

FIG. 20 illustrates an example signaling chart 2000 for direct UE-to-UE communication in accordance with some embodiments. For example, the signaling chart 2000 illustrates messages that may be exchanged and procedures that may be performed as part of an example direct UE-to-UE communication approach for user element predictive mobility in accordance with some embodiments.

The signaling chart 2000 includes a first UE 2002, a second UE 2004, a third UE 2006. Each of the first UE 2002, the second UE 2004, and the third UE 2006 may include one or more of the features of the UE 2400 (FIG. 24). The signaling and procedures illustrated by the signaling chart 2000 may be to support an HO decision of the first UE 2002.

The signaling chart 2000 includes a serving base station 2008 and a target base station 2010. Each of the serving base station 2008 and the target base station 2010 may include one or more of the features of the gNB 2500 (FIG. 25). The first UE 2002 may have a connection established with the serving base station 2008 at a beginning of the signaling chart 2000. The target base station 2010 may be a target base station for an HO operation of the first UE 2002 in the signaling chart 2000. The second UE 2004 and the third UE 2006 may have a connection with the target base station 2010.

UE 1 is connected to its serving gNB and the serving gNB initiates conditional handover cell preparation to obtain RRC reconfiguration of the target gNBs. For example, the first UE 2002 may be connected to the serving base station 2008 as indicated by 2012. The serving base station 2008 may initiate CHO preparation 2014 for the first UE 2002.

UE 1 continues to perform measurements according to the configuration set by the serving gNB. When UE 1 approaches the cell edge (e.g., the serving gNB signal strength falls below a threshold or the target gNB signal strength becomes better than a threshold), UE 1 can trigger data collection from other UEs around. For example, the first UE 2002 may continue to perform measurements in 2016. When the first UE 2002 approaches an edge of the cell hosted by the serving base station 2008, the first UE 2002 may trigger data collection from other UEs in 2016,

UE 1 sends a request to other UEs in the vicinity to collect data about their connectivity experience in terms of QoS, mean scheduling delay, channel condition, etc., via broadcast SIB messages using uplink shared channel (UL-SCH) or physical sidelink broadcast channel (PSBCH). For example, the first UE 2002 may generate and/or send a request to the second UE 2004 in 2018 requesting data of connectivity experience of the second UE 2004 with the target base station 2010. The first UE 2002 may generate and/or send a request to the third UE 2006 in 2020 requesting data of connectivity experience of the third UE 2006 with the target base station 2010.

The UE request can include target/prepared cell IDs and/or TCI states in some embodiments. The UE request can include UE trajectory prediction, predicted target cell IDs, and/or TCI states. For example, the requests transmitted by the first UE 2002 in 2018 and 2020 may include target/prepared cell IDs (including a cell ID corresponding to the target base station 2010) and/or TCI states for the first UE 2002 in some embodiments. In some embodiments, the requests transmitted by the first UE 2002 in 2018 and 2020 may include a UE trajectory prediction, predicted target cell IDs (including a cell ID corresponding to the target base station 2010), and/or TCI states for the first UE 2002.

There may be various conditions for a UE to send a response. For example, only the UEs that are on the trajectory of the requesting UE may report back. UEs that are relevant to UE 1 may send a response including their experience of the connectivity. The relevance may be decided if UEs are located within the trajectory of the UE 1. For example, the second UE 2004 and the third UE 2006 may check the response condition in 2022, where the response condition may be that only UEs along the trajectory prediction are to respond. The second UE 2004 may determine that it satisfies the response condition and the third UE 2006 may determine that it does not satisfy the response condition.

Accordingly, the second UE 2004 may determine that it is to respond based on satisfying the response condition and the third UE 2006 may determine that it is not to respond based on not satisfying the response condition. The second UE 2004 may generate and/or transmit a response to the first UE 2002 in 2022. The response may include a QoS indication, a load indication, a channel condition indication of the target base station 2010, and/or a TCI state indication.

The data exchange among the UEs may be performed via WiFi Direct, D2D, or Sidelink. For example, the requests and responses in 2018, 2022, and 2024 may be transmitted via WiFi Direct, D2D, or Sidelink.

UE 1 may evaluate the performance of other UEs around for handover decision. For example, the first UE 2002 may evaluate the information provided in the response from the second UE 2004 in 2026 for triggering an HO. The first UE 2002 may determine that the target base station 2010 satisfies the requirements of the first UE 2002. The first UE 2002 may perform an HO procedure 2028 with the target base station 2010 to transition the connection to the target base station 2010.

### Advantages

Below are provided some advantages of the approaches for supporting HO decisions described throughout this disclosure. It should be understood that the approaches may provide one or more of these advantages, but is not required to provide all of these advantages.

The quality of experience (QoE) of the UEs during mobility may be increased by finding the best cell based on the aggregated experience of the UEs. Otherwise, if the target cell of the UE does not satisfy QoE requirements, the UE may have to trigger another handover to a new cell, which would increase its service interruption time.

No dependence on the network to collect information about the experience of the other UEs. MNs are likely to be closer than the serving base station to the UE, thus the UE may require less transmit power to collect data (to support mobility decision) from the MN than the base station.

If UEs use the experience of the other UEs to support mobility decision, they may not need to perform frequent signal measurements of the serving and target cells for CHO execution condition. This can result in energy savings.

If the MNs that are in the vicinity of the UEs do not have data to support mobility decision of the UEs or the UEs do not receive response from the MNs within a certain time, the UEs can fall back to legacy conditional handover (CHO) mechanism based on the signal measurements. Therefore, in the worst-case scenario, the performance of CHO is guaranteed.

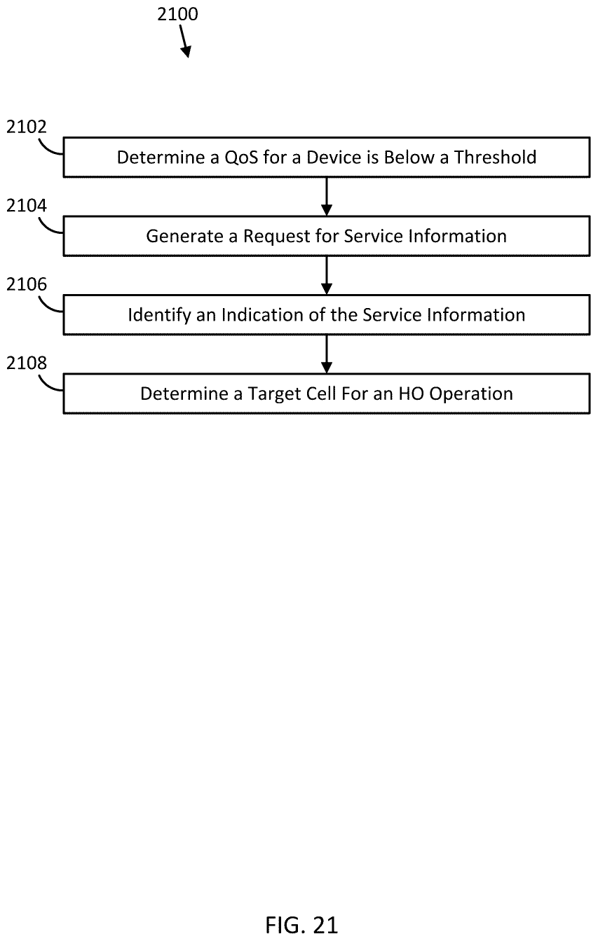

FIG. 21 illustrates an example procedure 2100 for determining a target cell for an HO operation in accordance with some embodiments. An HO operation may be performed to the determined target cell. The procedure 2100 may be performed by a UE, such as the UE 2400 (FIG. 24), or some portion thereof, such as the baseband processor 2404A (FIG. 24), the CPU 2404B (FIG. 24), and/or the GPU 2404C (FIG. 24).

The procedure 2100 may include determining a QoS for a device is below a threshold in 2102.

The procedure 2100 may include generating a request for service information in 2104. For example, the UE may generate a request for service information of one or more other devices serviced by one or more target cells. The request may include one or more cell IDs for the one or more target cells, one or more TCI states of the device, one or more measurement results of the device, or a predicted trajectory of the device.

In some embodiments, the request may be transmitted to an M-UE of a subnetwork in which the device is located. The request may be transmitted to a first device of the one or more other devices in some embodiments. In these embodiments, the request may be transmitted via a broadcast message or a unicast message that identifies the first device.

The procedure 2100 may include identifying an indication of the service information in 2106. For example, the UE may identify an indication of the service information of the one or more other devices. In some embodiments, the indication of the service information of the one or more other devices may be received from the M-UE.

In some embodiments, the indication of the service information of the one or more other devices may include an indication of the target cell. The indication of the service information of the one or more other devices may include a serving cell ID, a transmission configuration indicator (TCI) state, a channel condition, a QoS indication, or a mean scheduling delay for each of the one or more other devices in some embodiments. In some embodiments, the indication of the service information of the one or more other devices may include service information for a portion of the one or more other devices along a predicted trajectory of the device. The indication of the service information of the one or more other devices may include an indication of service information of the first device in some embodiments.

In some embodiments, the procedure 2100 may further include generating an M-UE mobility decision support request message for transmission to the M-UE. Further, the procedure 2100 may include identifying an M-UE mobility decision support indication received from the M-UE that indicates that the M-UE supports mobility decision operation. In some of these embodiments, the request for service information may be generated based at least in part on the M-UE mobility decision support indication indicating that the M-UE supports mobility decision operation.

In some embodiments, the procedure 2100 may further include identifying configuration information received from the M-UE to configure reporting of service information of the device. Further, the procedure 2100 may include generating a report of the service information of the device for transmission to the M-UE.

In some embodiments, the service information of the device may include a QoS indicator, a cell ID, a TCI state, a channel condition, a mean scheduling delay, or DL/UL load information of the device. The configuration information may indicate that the service information of the device is to be reported periodically or conditionally based on a threshold in some embodiments. In some embodiments, the report may be generated periodically or conditionally based on the threshold. The report may be transmitted to the M-UE via a PUSCH.

The procedure 2100 may include determining a target cell for an HO operation in 2108. For example, the UE may determine a target cell from the one or more target cells for an HO operation based at least in part on the service information of the one or more other devices.

While FIG. 21 may arguably imply an order of the operations of the procedure 2100, it should be understood that one or more of the operations may be performed in a different order and/or one or more of the operations may be performed concurrently in embodiments. Further, it should be understood that one or more of the operations may be omitted from and/or one or more additional operations may be added to the procedure 2100 in other embodiments.

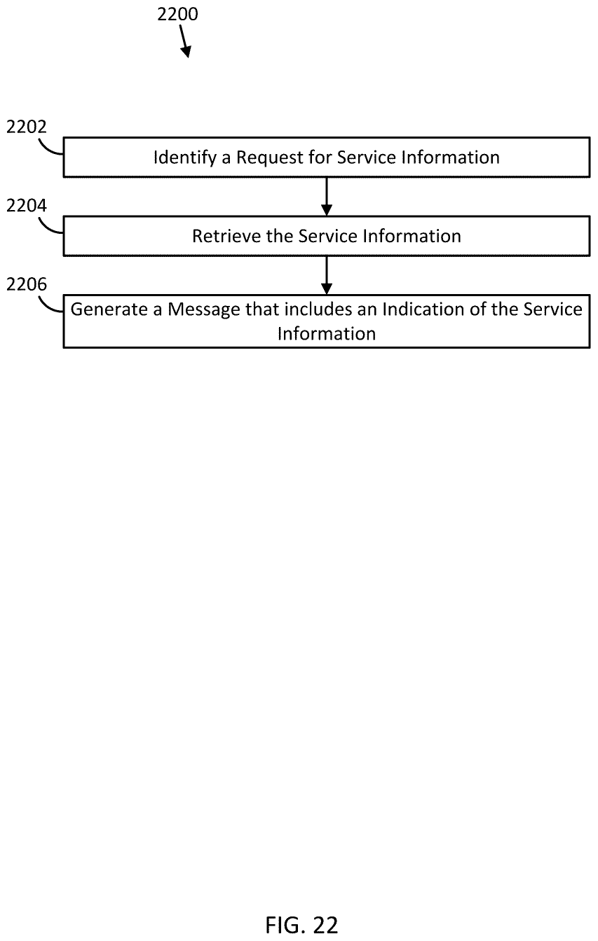

FIG. 22 illustrates an example procedure 2200 for indicating service information for a mobility decision in accordance with some embodiments. A UE may determine a target cell for an HO procedure based on the service information. The procedure 2200 may be performed by a UE, such as the UE 2400 (FIG. 24), or some portion thereof, such as the baseband processor 2404A (FIG. 24), the CPU 2404B (FIG. 24), and/or the GPU 2404C (FIG. 24).

The procedure 2200 may include identifying a request for service information in 2202. For example, the UE may identify a request for service information related to one or more target cells for a device. In some embodiments, the request for the service information related to the one or more target cells may include cell identifiers (IDs) for the one or more target cells, one or more transmission configuration indicator (TCI) states related to the device, one or more measurements of the device, or a predicted trajectory for the device.

In some embodiments, the procedure 2200 may further include identifying a management user equipment (M-UE) mobility decision support message received from the device. Further, the procedure 2200 may include generating an M-UE mobility decision support message to provide to indicate whether M-UE mobility decision support is supported.

The procedure 2200 may include retrieving the service information in 2204. For example, the UE may retrieve the service information related to the one or more target cells.

In some embodiments, retrieving the service information related to the one or more target cells may include retrieving the service information from memory. In some of these embodiments, the service information related to the one or more target cells may have been previously collected from one or more other devices and stored within the memory.

In some embodiments, retrieving the service information related to the one or more target cells may includes generating one or more service information requests for the service information related to the one or more target cells to be provided to one or more other devices. Further, retrieving the service information related to the one or more target cells may include identifying one or more portions of the service information received from at least a portion of the one or more other devices in some embodiments. In these embodiments, the one or more other devices may include one or more other M-UEs.

In some embodiments, the procedure 2200 may include determining a predicted trajectory of the device from the request for the service information related to the one or more target cells. Further, the procedure 2200 may include determining one or more other devices along the predicted trajectory of the device in some embodiments. In some of these embodiments, retrieving the service information related to the one or more target cells includes retrieving the service information from the one or more other devices.

In some embodiments, the procedure 2200 may further include generating one or more configuration messages for one or more other devices, the one or more configuration messages to configure the one or more other devices to provide corresponding service information of the one or more other devices periodically or conditionally based on a threshold. In some of these embodiments, the procedure 2200 may further include identifying one or more service information messages received from the one or more other devices. The procedure 2200 may include updating a stored copy of the service information related to the one or more target cells based at least in part on the one or more service information messages in some of these embodiments.

The procedure 2200 may include generating a message that includes an indication of the service information in 2206. For example, the UE may generate a message that includes an indication of the service information related to the one or more target cells. In some embodiments, the indication of the service information related to the one or more target cells may include cell IDs corresponding to the one or more target cells, TCI states related to the one or more target cells, channel conditions related to the one or more target cells, QoS indications related to the one or more target cells, or mean scheduling delays related to the one or more target cells.

In some embodiments, the procedure 2200 may further include determining a target cell from the one or more target cells for a handover (HO) based at least in part on the service information related to the one or more target cells. In some of these embodiments, the indication of the service information may include an indication of the target cell.

In some embodiments, the procedure 2200 may further include generating a table with the service information related to the one or more target cells. The message may include the table in some of these embodiments.

While FIG. 22 may arguably imply an order of the operations of the procedure 2200, it should be understood that one or more of the operations may be performed in a different order and/or one or more of the operations may be performed concurrently in embodiments. Further, it should be understood that one or more of the operations may be omitted from and/or one or more additional operations may be added to the procedure 2200 in other embodiments.

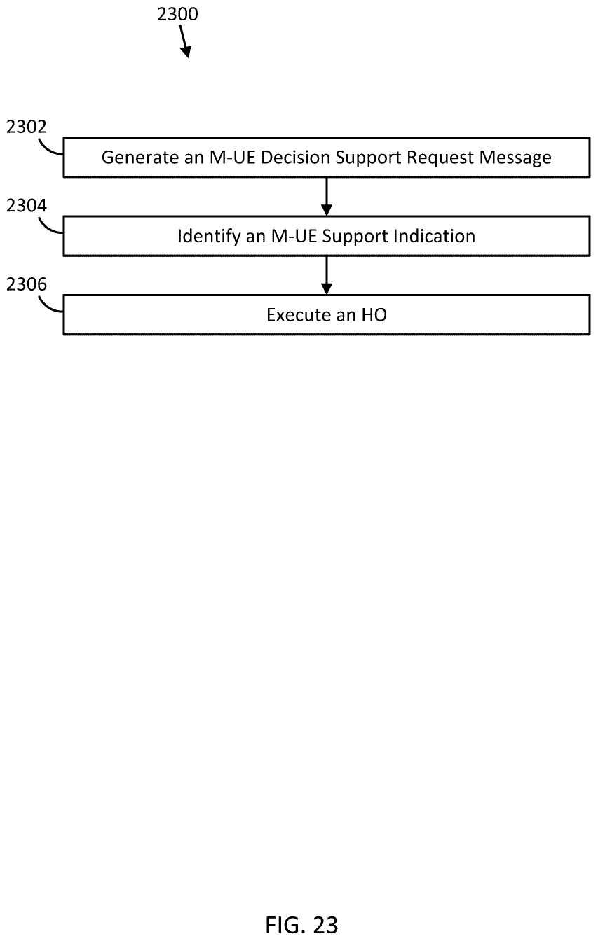

FIG. 23 illustrates an example procedure 2300 for determining a target cell for an HO operation in accordance with some embodiments. An HO operation may be performed to the determined target cell. The procedure 2300 may be performed by a UE, such as the UE 2400 (FIG. 24), or some portion thereof, such as the baseband processor 2404A (FIG. 24), the CPU 2404B (FIG. 24), and/or the GPU 2404C (FIG. 24).

The procedure 2300 may include generating an M-UE decision support request message in 2302. For example, the UE may generate a management user equipment (M-UE) decision support request message for transmission to a M-UE.

The procedure 2300 may include identifying an M-UE support indication in 2304. For example, the UE may identify an M-UE mobility decision support indication received from the M-UE that indicates whether the M-UE supports mobility decision operation. In some embodiments, the M-UE mobility decision support indication may indicate that the M-UE supports mobility decision operation.

The procedure 2300 may include executing an HO in 2306. For example, the UE may execute an HO in accordance with whether the M-UE supports mobility decision operation.

In some embodiments, the procedure 2300 may further include determining that a quality of service (QOS) for a device is below a threshold. Further, the procedure 2300 may include generating a request for service information of one or more other devices serviced by one or more target cells for the device in some embodiments. In some embodiments, the procedure 2300 may include identifying an indication of the service information of the one or more other devices. The procedure 2300 may include determining a target cell from the one or more target cells based at least in part on the service information of the one or more other devices, wherein the HO causes the device to establish a connection with the target cell.

In some embodiments, the indication of the service information of the one or more other devices may include a serving cell ID, a TCI state, a channel conditions, a QoS indication, or a mean scheduling delay for each of the one or more other devices. The indication of the service information of the one or more other devices may include service information for a portion of the one or more other devices along a predicted trajectory of the device in some embodiments. In some embodiments, the request may include one or more cell IDs for the one or more target cells, one or more TCI states of the device, one or more measurement results of the device, or a predicted trajectory of the device.

In some embodiments, the procedure 2300 may further include identifying configuration information received from the M-UE to configure reporting of service information of the device. Further, the procedure 2300 may include generating a report of the service information of the device for transmission to the M-UE.

In some embodiments, the service information of the device may include a QoS indicator, a cell ID, a TCI state, a channel condition, a mean scheduling delay, or DL/UL load information of the device. The configuration information may indicate that the service information of the device is to be reported periodically or conditionally based on a threshold in some embodiments. In some embodiments, the report is generated periodically or conditionally based on the threshold. The report may be transmitted to the M-UE via a physical uplink shared channel (PUSCH) in some embodiments.

While FIG. 23 may arguably imply an order of the operations of the procedure 2300, it should be understood that one or more of the operations may be performed in a different order and/or one or more of the operations may be performed concurrently in embodiments. Further, it should be understood that one or more of the operations may be omitted from and/or one or more additional operations may be added to the procedure 2300 in other embodiments.

FIG. 24 illustrates an example UE 2400 in accordance with some embodiments. The UE 2400 may be any mobile or non-mobile computing device, such as, for example, mobile phones, computers, tablets, industrial wireless sensors (for example, microphones, carbon dioxide sensors, pressure sensors, humidity sensors, thermometers, motion sensors, accelerometers, laser scanners, fluid level sensors, inventory sensors, electric voltage/current meters, actuators, etc.), video surveillance/monitoring devices (for example, cameras, video cameras, etc.), wearable devices (for example, a smart watch), relaxed-IoT devices. In some embodiments, the UE 2400 may be a RedCap UE or NR-Light UE.

The UE 2400 may include processors 2404, RF interface circuitry 2408, memory/storage 2412, user interface 2416, sensors 2420, driver circuitry 2422, power management integrated circuit (PMIC) 2424, antenna structure 2426, and battery 2428. The components of the UE 2400 may be implemented as integrated circuits (ICs), portions thereof, discrete electronic devices, or other modules, logic, hardware, software, firmware, or a combination thereof. The block diagram of FIG. 24 is intended to show a high-level view of some of the components of the UE 2400. However, some of the components shown may be omitted, additional components may be present, and different arrangement of the components shown may occur in other implementations.

The components of the UE 2400 may be coupled with various other components over one or more interconnects 2432, which may represent any type of interface, input/output, bus (local, system, or expansion), transmission line, trace, optical connection, etc. that allows various circuit components (on common or different chips or chipsets) to interact with one another.

The processors 2404 may include processor circuitry such as, for example, baseband processor circuitry (BB) 2404A, central processor unit circuitry (CPU) 2404B, and graphics processor unit circuitry (GPU) 2404C. The processors 2404 may include any type of circuitry or processor circuitry that executes or otherwise operates computer-executable instructions, such as program code, software modules, or functional processes from memory/storage 2412 to cause the UE 2400 to perform operations as described herein. The processors 2404 may further include interface circuitry 2404D. The interface circuitry 2404D may communicatively couple one or more of the BB 2404A, the CPU 2404B, and/or the GPU 2404C to each other and/or to other components of the UE 2400, such as the memory/storage 2412, the sensors 2420, the driver circuitry 2422, the PMIC 2424, the user interface 2416, the battery 2428, and/or the RF interface circuitry 2408. The interface circuitry 2404D may comprise wired connections (such as traces, vias, and/or wires) or wireless connections to facilitate the communicative coupling.

In some embodiments, the baseband processor circuitry 2404A may access a communication protocol stack 2436 in the memory/storage 2412 to communicate over a 3GPP compatible network. In general, the baseband processor circuitry 2404A may access the communication protocol stack to: perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a non-access stratum layer. In some embodiments, the PHY layer operations may additionally/alternatively be performed by the components of the RF interface circuitry 2408.

The baseband processor circuitry 2404A may generate or process baseband signals or waveforms that carry information in 3GPP-compatible networks. In some embodiments, the waveforms for NR may be based cyclic prefix OFDM (CP-OFDM) in the uplink or downlink, and discrete Fourier transform spread OFDM (DFT-S-OFDM) in the uplink.

The memory/storage 2412 may include one or more non-transitory, computer-readable media that includes instructions (for example, communication protocol stack 2436) that may be executed by one or more of the processors 2404 to cause the UE 2400 to perform various operations described herein. The memory/storage 2412 include any type of volatile or non-volatile memory that may be distributed throughout the UE 2400. In some embodiments, some of the memory/storage 2412 may be located on the processors 2404 themselves (for example, L1 and L2 cache), while other memory/storage 2412 is external to the processors 2404 but accessible thereto via a memory interface. The memory/storage 2412 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 2408 may include transceiver circuitry and radio frequency front module (RFEM) that allows the UE 2400 to communicate with other devices over a radio access network. The RF interface circuitry 2408 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via antenna structure 2426 and proceed to filter and amplify (with a low-noise amplifier) the signal. The signal may be provided to a receiver of the transceiver that down-converts the RF signal into a baseband signal that is provided to the baseband processor of the processors 2404.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna structure 2426.

In various embodiments, the RF interface circuitry 2408 may be configured to transmit/receive signals in a manner compatible with NR access technologies.

The antenna structure 2426 may include antenna elements to convert electrical signals into radio waves to travel through the air and to convert received radio waves into electrical signals. The antenna elements may be arranged into one or more antenna panels. The antenna structure 2426 may have antenna panels that are omnidirectional, directional, or a combination thereof to enable beamforming and multiple input, multiple output communications. The antenna structure 2426 may include microstrip antennas, printed antennas fabricated on the surface of one or more printed circuit boards, patch antennas, phased array antennas, etc. The antenna structure 2426 may have one or more panels designed for specific frequency bands including bands in FR1 or FR2.

The user interface 2416 includes various input/output (I/O) devices designed to enable user interaction with the UE 2400. The user interface 2416 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes “LEDs” and multi-character visual outputs, or more complex outputs such as display devices or touchscreens (for example, liquid crystal displays (LCDs), LED displays, quantum dot displays, projectors, etc.), with the output of characters, graphics, multimedia objects, and the like being generated or produced from the operation of the UE 2400.

The sensors 2420 may include devices, modules, or subsystems whose purpose is to detect events or changes in its environment and send the information (sensor data) about the detected events to some other device, module, subsystem, etc. Examples of such sensors include, inter alia, inertia measurement units comprising accelerometers, gyroscopes, or magnetometers; microelectromechanical systems or nanoelectromechanical systems comprising 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 2422 may include software and hardware elements that operate to control particular devices that are embedded in the UE 2400, attached to the UE 2400, or otherwise communicatively coupled with the UE 2400. The driver circuitry 2422 may include individual drivers allowing other components to interact with or control various input/output (I/O) devices that may be present within, or connected to, the UE 2400. For example, driver circuitry 2422 may include a display driver to control and allow access to a display device, a touchscreen driver to control and allow access to a touchscreen interface, sensor drivers to obtain sensor readings of sensor circuitry 2420 and control and allow access to sensor circuitry 2420, drivers to obtain actuator positions of electro-mechanic components or control and allow access to the electro-mechanic components, a camera driver to control and allow access to an embedded image capture device, audio drivers to control and allow access to one or more audio devices.

The PMIC 2424 may manage power provided to various components of the UE 2400. In particular, with respect to the processors 2404, the PMIC 2424 may control power-source selection, voltage scaling, battery charging, or DC-to-DC conversion.

In some embodiments, the PMIC 2424 may control, or otherwise be part of, various power saving mechanisms of the UE 2400. For example, if the platform UE is in an RRC_Connected state, where it is still connected to the RAN node as it expects to receive traffic shortly, then it may enter a state known as Discontinuous Reception Mode (DRX) after a period of inactivity. During this state, the UE 2400 may power down for brief intervals of time and thus save power. If there is no data traffic activity for an extended period of time, then the UE 2400 may transition off to an RRC_Idle state, where it disconnects from the network and does not perform operations such as channel quality feedback, handover, etc. The UE 2400 goes into a very low power state and it performs paging where again it periodically wakes up to listen to the network and then powers down again. The UE 2400 may not receive data in this state; in order to receive data, it must transition back to RRC_Connected state. An additional power saving mode may allow a device to be unavailable to the network for periods longer than a paging interval (ranging from seconds to a few hours). During this time, the device is totally unreachable to the network and may power down completely. Any data sent during this time incurs a large delay and it is assumed the delay is acceptable.

A battery 2428 may power the UE 2400, although in some examples the UE 2400 may be mounted deployed in a fixed location, and may have a power supply coupled to an electrical grid. The battery 2428 may be a lithium ion battery, a metal-air battery, such as a zinc-air battery, an aluminum-air battery, a lithium-air battery, and the like. In some implementations, such as in vehicle-based applications, the battery 2428 may be a typical lead-acid automotive battery.

FIG. 25 illustrates an example gNB 2500 in accordance with some embodiments. The gNB 2500 may include processors 2504, RF interface circuitry 2508, core network (CN) interface circuitry 2512, memory/storage circuitry 2516, and antenna structure 2526.

The components of the gNB 2500 may be coupled with various other components over one or more interconnects 2528.

The processors 2504, RF interface circuitry 2508, memory/storage circuitry 2516 (including communication protocol stack 2510), antenna structure 2526, and interconnects 2528 may be similar to like-named elements shown and described with respect to FIG. 24.

The processors 2504 may further include interface circuitry 2504D. The interface circuitry 2504D may communicatively couple one or more of the BB 2504A, the CPU 2504B, and/or the GPU 2504C to each other and/or to other components of the gNB 2500, such as the memory/storage circuitry 2516, the CN interface circuitry 2512, and/or the RAN interface circuitry. The interface circuitry 2504D may comprise wired connections (such as traces, vias, and/or wires) or wireless connections to facilitate the communicative coupling.

The CN interface circuitry 2512 may provide connectivity to a core network, for example, a 5th Generation Core network (5GC) using a 5GC-compatible network interface protocol such as carrier Ethernet protocols, or some other suitable protocol. Network connectivity may be provided to/from the gNB 2500 via a fiber optic or wireless backhaul. The CN interface circuitry 2512 may include one or more dedicated processors or FPGAs to communicate using one or more of the aforementioned protocols. In some implementations, the CN interface circuitry 2512 may include multiple controllers to provide connectivity to other networks using the same or different protocols.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### Examples

In the following sections, further exemplary embodiments are provided.

Example 1 may include a method comprising determining a quality of service (QoS) for a device is below a threshold, generating a request for service information of one or more other devices serviced by one or more target cells, identifying an indication of the service information of the one or more other devices, and determining a target cell from the one or more target cells for a handover (HO) operation based at least in part on the service information of the one or more other devices.

Example 2 may include the method of example 1, wherein the request is to be transmitted to a management user equipment (M-UE) of a subnetwork in which the device is located, and wherein the indication of the service information of the one or more other devices is received from the M-UE.

Example 3 may include the method of example 2, wherein the indication of the service information of the one or more other devices includes an indication of the target cell.

Example 4 may include the method of example 2, wherein the indication of the service information of the one or more other devices includes a serving cell identifier (ID), a transmission configuration indicator (TCI) state, a channel condition, a QoS indication, or a mean scheduling delay for each of the one or more other devices.

Example 5 may include the method of example 2, wherein the indication of the service information of the one or more other devices includes service information for a portion of the one or more other devices along a predicted trajectory of the device.

Example 6 may include the method of example 2 further comprising generating an M-UE mobility decision support request message for transmission to the M-UE, and identifying an M-UE mobility decision support indication received from the M-UE that indicates that the M-UE supports mobility decision operation, wherein the request for service information is generated based at least in part on the M-UE mobility decision support indication indicating that the M-UE supports mobility decision operation.

Example 7 may include the method of example 2 further comprising identifying configuration information received from the M-UE to configure reporting of service information of the device, and generating a report of the service information of the device for transmission to the M-UE.

Example 8 may include the method of example 7, wherein the service information of the device includes a QoS indicator, a cell identifier (ID), a transmission configuration indicator (TCI) state, a channel condition, a mean scheduling delay, or downlink (DL)/uplink (UL) load information of the device.

Example 9 may include the method of example 7, wherein the configuration information indicates that the service information of the device is to be reported periodically or conditionally based on a threshold, and wherein the report is generated periodically or conditionally based on the threshold.

Example 10 may include the method of example 7, wherein the report is transmitted to the M-UE via a physical uplink shared channel (PUSCH).

Example 11 may include the method of example 1, wherein the request is to be transmitted to a first device of the one or more other devices, and wherein the indication of the service information of the one or more other devices includes an indication of service information of the first device.

Example 12 may include the method of example 11, wherein the request is transmitted via a broadcast message or a unicast message that identifies the first device.

Example 13 may include the method of example 1, wherein the request includes one or more cell identifiers (IDs) for the one or more target cells, one or more transmission configuration indicator (TCI) states of the device, one or more measurement results of the device, or a predicted trajectory of the device.

Example 14 may include a method comprising identifying a request for service information related to one or more target cells for a device, retrieving the service information related to the one or more target cells, and generating a message that includes an indication of the service information related to the one or more target cells.

Example 15 may include the method of example 14, wherein retrieving the service information related to the one or more target cells includes retrieving the service information from memory.

Example 16 may include the method of example 15, wherein the service information related to the one or more target cells has been previously collected from one or more other devices and stored within the memory.

Example 17 may include the method of example 14, wherein retrieving the service information related to the one or more target cells includes generating one or more service information requests for the service information related to the one or more target cells to be provided to one or more other devices, and identifying one or more portions of the service information received from at least a portion of the one or more other devices.

Example 18 may include the method of example 17, wherein the one or more other devices includes one or more other management user equipments (M-UEs).

Example 19 may include the method of example 14, further comprising determining a predicted trajectory of the device from the request for the service information related to the one or more target cells, and determining one or more other devices along the predicted trajectory of the device, wherein retrieving the service information related to the one or more target cells includes retrieving the service information from the one or more other devices.

Example 20 may include the method of example 14 further comprising determining a target cell from the one or more target cells for a handover (HO) based at least in part on the service information related to the one or more target cells, wherein the indication of the service information includes an indication of the target cell.

Example 21 may include the method of example 14 further comprising generating a table with the service information related to the one or more target cells, wherein the message includes the table.

Example 22 may include the method of example 14, wherein the indication of the service information related to the one or more target cells includes cell identifiers (IDs) corresponding to the one or more target cells, transmission configuration indicator (TCI) states related to the one or more target cells, channel conditions related to the one or more target cells, quality of service (QOS) indications related to the one or more target cells, or mean scheduling delays related to the one or more target cells.

Example 23 may include the method of example 14, wherein the request for the service information related to the one or more target cells includes cell identifiers (IDs) for the one or more target cells, one or more transmission configuration indicator (TCI) states related to the device, one or more measurements of the device, or a predicted trajectory for the device.

Example 24 may include the method of example 14 further comprising generating one or more configuration messages for one or more other devices, the one or more configuration messages to configure the one or more other devices to provide corresponding service information of the one or more other devices periodically or conditionally based on a threshold.

Example 25 may include the method of example 24 further comprising identifying one or more service information messages received from the one or more other devices, and updating a stored copy of the service information related to the one or more target cells based at least in part on the one or more service information messages.

Example 26 may include the method of example 14 further comprising identifying a management user equipment (M-UE) mobility decision support message received from the device, and generating an M-UE mobility decision support message to provide to indicate whether M-UE mobility decision support is supported.

Example 27 may include a method comprising generating a management user equipment (M-UE) decision support request message for transmission to a M-UE, identifying an M-UE mobility decision support indication received from the M-UE that indicates whether the

M-UE supports mobility decision operation, and executing a handover (HO) in accordance with whether the M-UE supports mobility decision operation.

Example 28 may include the method of example 27, wherein the M-UE mobility decision support indication indicates that the M-UE supports mobility decision operation, and wherein the method further comprises determining that a quality of service (QOS) for a device is below a threshold, generating a request for service information of one or more other devices serviced by one or more target cells for the device, identifying an indication of the service information of the one or more other devices, and determining a target cell from the one or more target cells based at least in part on the service information of the one or more other devices, wherein the HO causes the device to establish a connection with the target cell.

Example 29 may include the method of example 28, wherein the indication of the service information of the one or more other devices includes a serving cell identifier (ID), a transmission configuration indicator (TCI) state, a channel conditions, a QoS indication, or a mean scheduling delay for each of the one or more other devices.

Example 30 may include the method of example 28, wherein the indication of the service information of the one or more other devices includes service information for a portion of the one or more other devices along a predicted trajectory of the device.

Example 31 may include the method of example 28 further comprising identifying configuration information received from the M-UE to configure reporting of service information of the device, and generating a report of the service information of the device for transmission to the M-UE.

Example 32 may include the method of example 31, wherein the service information of the device includes a QoS indicator, a cell identifier (ID), a transmission configuration indicator (TCI) state, a channel condition, a mean scheduling delay, or downlink (DL)/uplink (UL) load information of the device.

Example 33 may include the method of example 31, wherein the configuration information indicates that the service information of the device is to be reported periodically or conditionally based on a threshold, and wherein the report is generated periodically or conditionally based on the threshold.

Example 34 may include the method of example 31, wherein the report is transmitted to the M-UE via a physical uplink shared channel (PUSCH).

Example 35 may include the method of example 28, wherein the request includes one or more cell identifiers (IDs) for the one or more target cells, one or more transmission configuration indicator (TCI) states of the device, one or more measurement results of the device, or a predicted trajectory of the device.

Example 36 may include an apparatus comprising means to perform one or more elements of a method described in or related to any of examples 1-35, or any other method or process described herein.

Example 37 may include one or more non-transitory computer-readable media comprising instructions to cause an electronic device, upon execution of the instructions by one or more processors of the electronic device, to perform one or more elements of a method described in or related to any of examples 1-35, or any other method or process described herein.

Example 38 may include an apparatus comprising logic, modules, or circuitry to perform one or more elements of a method described in or related to any of examples 1-35, or any other method or process described herein.

Example 39 may include a method, technique, or process as described in or related to any of examples 1-35, or portions or parts thereof.

Example 40 may include an apparatus comprising: one or more processors and one or more computer-readable media comprising instructions that, when executed by the one or more processors, cause the one or more processors to perform the method, techniques, or process as described in or related to any of examples 1-35, or portions thereof.

Example 41 may include a signal as described in or related to any of examples 1-35, or portions or parts thereof.

Example 42 may include a datagram, information element, packet, frame, segment, PDU, or message as described in or related to any of examples 1-35, or portions or parts thereof, or otherwise described in the present disclosure.

Example 43 may include a signal encoded with data as described in or related to any of examples 1-35, or portions or parts thereof, or otherwise described in the present disclosure.

Example 44 may include a signal encoded with a datagram, IE, packet, frame, segment, PDU, or message as described in or related to any of examples 1-35, or portions or parts thereof, or otherwise described in the present disclosure.

Example 45 may include an electromagnetic signal carrying computer-readable instructions, wherein execution of the computer-readable instructions by one or more processors is to cause the one or more processors to perform the method, techniques, or process as described in or related to any of examples 1-35, or portions thereof.

Example 46 may include a computer program comprising instructions, wherein execution of the program by a processing element is to cause the processing element to carry out the method, techniques, or process as described in or related to any of examples 1-35, or portions thereof.

Example 47 may include a signal in a wireless network as shown and described herein.

Example 48 may include a method of communicating in a wireless network as shown and described herein.

Example 49 may include a system for providing wireless communication as shown and described herein.

Example 50 may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. One or more non-transitory, computer-readable media having instructions that, when executed, cause processing circuitry to:
determine a quality of service (QOS) for a device is below a threshold;
generate a request for service information of one or more other devices serviced by one or more target cells;
identify an indication of the service information of the one or more other devices; and
determine a target cell from the one or more target cells for a handover (HO) operation based at least in part on the service information of the one or more other devices.

2. The one or more non-transitory, computer-readable media of claim 1, wherein the request is to be transmitted to a management user equipment (M-UE) of a subnetwork in which the device is located, and wherein the indication of the service information of the one or more other devices is received from the M-UE.

3. The one or more non-transitory, computer-readable media of claim 2, wherein the indication of the service information of the one or more other devices includes an indication of the target cell.

4. The one or more non-transitory, computer-readable media of claim 2, wherein the indication of the service information of the one or more other devices includes a serving cell identifier (ID), a transmission configuration indicator (TCI) state, a channel condition, a QoS indication, or a mean scheduling delay for each of the one or more other devices.

5. The one or more non-transitory, computer-readable media of claim 2, wherein the indication of the service information of the one or more other devices includes service information for a portion of the one or more other devices along a predicted trajectory of the device.

6. The one or more non-transitory, computer-readable media of claim 2, wherein the instructions, when executed, further cause the processing circuitry to:
generate an M-UE mobility decision support request message for transmission to the M-UE; and
identify an M-UE mobility decision support indication received from the M-UE that indicates that the M-UE supports mobility decision operation, wherein the request for service information is generated based at least in part on the M-UE mobility decision support indication indicating that the M-UE supports mobility decision operation.

7. The one or more non-transitory, computer-readable media of claim 2, wherein the instructions, when executed, further cause the processing circuitry to:
identify configuration information received from the M-UE to configure reporting of service information of the device; and
generate a report of the service information of the device for transmission to the M-UE.

8. The one or more non-transitory, computer-readable media of claim 1, wherein the request is to be transmitted to a first device of the one or more other devices, and wherein the indication of the service information of the one or more other devices includes an indication of service information of the first device.

9. The one or more non-transitory, computer-readable media of claim 1, wherein the request includes one or more cell identifiers (IDs) for the one or more target cells, one or more transmission configuration indicator (TCI) states of the device, one or more measurement results of the device, or a predicted trajectory of the device.

10. An apparatus comprising:
processing circuitry to:
identify a request for service information related to one or more target cells for a device;
retrieve the service information related to the one or more target cells; and
generate a message that includes an indication of the service information related to the one or more target cells; and
interface circuitry coupled with the processing circuitry, the interface circuitry to enable communication.

11. The apparatus of claim 10, wherein to retrieve the service information related to the one or more target cells includes to:
generate one or more service information requests for the service information related to the one or more target cells to be provided to one or more other devices; and
identify one or more portions of the service information received from at least a portion of the one or more other devices.

12. The apparatus of claim 10, wherein the processing circuitry is further to:
determining a predicted trajectory of the device from the request for the service information related to the one or more target cells; and
determine one or more other devices along the predicted trajectory of the device, wherein to retrieve the service information related to the one or more target cells includes to retrieve the service information from the one or more other devices.

13. The apparatus of claim 10, wherein the processing circuitry is further to:
determine a target cell from the one or more target cells for a handover (HO) based at least in part on the service information related to the one or more target cells, wherein the indication of the service information includes an indication of the target cell.

14. The apparatus of claim 10, wherein the indication of the service information related to the one or more target cells includes cell identifiers (IDs) corresponding to the one or more target cells, transmission configuration indicator (TCI) states related to the one or more target cells, channel conditions related to the one or more target cells, quality of service (QoS) indications related to the one or more target cells, or mean scheduling delays related to the one or more target cells.

15. The apparatus of claim 10, wherein the processing circuitry is further to:
generate one or more configuration messages for one or more other devices, the one or more configuration messages to configure the one or more other devices to provide corresponding service information of the one or more other devices periodically or conditionally based on a threshold.

16. The apparatus of claim 10, wherein the processing circuitry is further to:
identify a management user equipment (M-UE) mobility decision support message received from the device; and
generate an M-UE mobility decision support message to provide to indicate whether M-UE mobility decision support is supported.

17. A method comprising:
generating a management user equipment (M-UE) decision support request message for transmission to a M-UE;
identifying an M-UE mobility decision support indication received from the M-UE that indicates whether the M-UE supports mobility decision operation; and
executing a handover (HO) in accordance with whether the M-UE supports mobility decision operation.

18. The method of claim 17, wherein the M-UE mobility decision support indication indicates that the M-UE supports mobility decision operation, and wherein the method further comprises:
determining that a quality of service (QOS) for a device is below a threshold;
generating a request for service information of one or more other devices serviced by one or more target cells for the device;
identifying an indication of the service information of the one or more other devices; and
determining a target cell from the one or more target cells based at least in part on the service information of the one or more other devices, wherein the HO causes the device to establish a connection with the target cell.

19. The method of claim 18, wherein the indication of the service information of the one or more other devices includes a serving cell identifier (ID), a transmission configuration indicator (TCI) state, a channel conditions, a QoS indication, or a mean scheduling delay for each of the one or more other devices.

20. The method of claim 18, further comprising:
identifying configuration information received from the M-UE to configure reporting of service information of the device; and
generating a report of the service information of the device for transmission to the M-UE.
